(19) United States
(12) Patent Application Publication
(10) Pub. No.: US 2012/0033160 A1
(43) Pub. Date: Feb. 9, 2012

(54) LIQUID CRYSTAL DISPLAY DEVICE

(76) Inventors: Kunihiro Tashiro, Osaka (JP); Takayuki Hayano, Osaka (JP); Shogo Nishiwaki, Osaka (JP)

(21) Appl. No.: 13/262,056

(22) PCT Filed: Mar. 25, 2010
(86) PCT No.: PCT/JP2010/002101

§ 371 Date: Sep. 29, 2011

(30) Foreign Application Priority Data
Mar. 31, 2009 (JP) 2009-086767

(51) Int. Cl. G02F 1/1335

(52) U.S. Cl. 349/103

(57) ABSTRACT

In a liquid crystal display device using pixel electrodes having a fishbone structure as well as using the PSA technology, the occurrence of an azimuthal angle shift in the vicinity of the pixel edge is suppressed. A liquid crystal display device according to the present invention is a liquid crystal display device comprising a plurality of pixels and a pair of polarizing plates located in crossed Nicols and providing display in a normally black mode. Each of the plurality of pixels includes a liquid crystal layer containing liquid crystal molecules having a negative dielectric anisotropy; a pixel electrode and a counter electrode facing each other with the liquid crystal layer interposed therebetween; a pair of vertical alignment films respectively provided between the pixel electrode and the liquid crystal layer and between the counter electrode and the liquid crystal layer; and a pair of alignment sustaining layers respectively provided on surfaces of the pair of vertical alignment films on the liquid crystal layer side and formed of a photopolymerizable material. The pixel electrode includes a cross-shaped trunk portion located so as to overlap polarization axes of the pair of polarizing plates, a plurality of branch portions extending from the trunk portion in a direction having an angle of about 45° with respect thereto, and a plurality of slits formed between the plurality of branch portions. The pixel electrode has an overall shape which is a generally parallelogram shape with four right angles, each of four sides of which has an angle of about 45° with respect to the polarization axes of the pair of polarizing plates. The plurality of branch portions are located generally symmetrically with respect to the trunk portion.

### TECHNICAL FIELD

The present invention relates to a liquid crystal display device, and specifically to a liquid crystal display device in which a 4-domain alignment structure is formed in each of pixels in the presence of a voltage.

### BACKGROUND ART

Currently, as liquid crystal display devices having a wide viewing angle characteristic, liquid crystal display devices of transverse electric field modes (including an IPS mode and an FFS mode) and liquid crystal display devices of vertical alignment modes (VA modes) are used. The VA modes are more suitable for mass production than the transverse electric field modes and so are widely used for TVs and mobile devices. Among the VA modes, an MVA mode is most widely used. The MVA mode is disclosed in, for example, Patent Document 1.

In an MVA-mode liquid crystal display device, linear alignment regulation means (slits or ribs formed in or on electrodes) are located in two directions perpendicular to each other, and four liquid crystal domains are formed between the linear alignment regulation means. The azimuthal angle of directors which are representative of respective liquid crystal domains is 45° with respect to polarization axes (transmission axes) of a pair of polarizing plates placed in crossed Nicols. Where the azimuths of the polarization axes (transmission axes) are 0° and 90°, the azimuthal angles of the directors of the four liquid crystal domains are 45°, 135°, 225° and 315°. The structure in which four domains are formed in one pixel is referred to as the “4-domain alignment structure” or simply as the “4D structure”.

For the purpose of improving the responsiveness of the MVA-mode liquid crystal display devices, the technology called the “polymer sustained alignment” (occasionally referred to as the “PSA technology” has been developed (see, for example, Patent Documents 2 through 7). According to the PSA technology, after a liquid crystal cell is produced, a photopolymerizable monomer mixed in a liquid crystal material in advance is polymerized in the state where the liquid crystal layer is supplied with a voltage. Thus, an alignment sustaining layer (“polymer layer”) is formed, and this is used to pretilt liquid crystal molecules. By adjusting the distribution and strength of the electric field applied for polymerizing the monomer, the pretilt azimuth (azimuthal angle in the substrate plane) and the pretilt angle (angle of rise from the substrate plane) of the liquid crystal molecules can be controlled.

Patent Documents 3 through 7 also disclose a structure which uses a pixel electrode having a minute striped pattern as well as the PSA technology. According to this structure, when a voltage is applied to the liquid crystal layer, the liquid crystal molecules are aligned parallel to a longitudinal direction of the striped pattern. This is contrasting to the conventional MVA-mode liquid crystal display device described in Patent Document 1, in which the liquid crystal molecules are aligned perpendicular to the linear alignment regulation structures such as slits, ribs or the like. The lines and spaces of the minute striped pattern (occasionally referred to as the “fishbone structure”) may have a width smaller than the width of the alignment regulation means of the conventional MVA-mode liquid crystal display device. Therefore, the fishbone structure has an advantage of being applicable to small pixels more easily than the alignment regulation means of the conventional MVA-mode liquid crystal display device.

FIG. 23 shows a conventional liquid crystal display device 500 including pixel electrodes 512 having a fishbone structure. As shown in FIG. 23, the pixel electrodes 512 of the liquid crystal display device 500 each include a cross-shaped trunk portion 512a located so as to overlap polarization axes P1 and P2 of a pair of polarizing plates located in crossed Nicols, a plurality of branch portions 512b extending from the trunk portion 12a in a direction having an angle of about 45° with respect thereto, and a plurality of slits 512c formed between the plurality of branch portions 512b. The pixel electrode 512 is electrically connected to a thin film transistor (TFT) 513. The TFT 513 is supplied with a scanning signal from a scanning line 514 and an image signal from a signal line 515.

FIG. 24 shows the relationship between the fishbone structure of the pixel electrode 512 and the azimuths of directors of liquid crystal domains. As shown in FIG. 24, the trunk portion 512a of the pixel electrode 512 includes a linear portion (horizontal linear portion) 512a1 extending in a horizontal direction and a linear portion (vertical linear portion) 512a2 extending in a vertical direction. The horizontal linear portion 512a1 and the vertical linear portion 512a2 cross each other (perpendicularly) at the center of the pixel.

The plurality of branch portions 512b are divided into four groups corresponding to four areas separated from each other by the cross-shaped trunk portion 512a. It is now assumed that the display plane is the face of a clock, that the azimuthal angle of 0° corresponds to the 9 o'clock direction, and that the clockwise direction is a forward direction. With such assumptions, the plurality of branch portions 512b are divided into a first group of branch portions 512b1 extending in an azimuthal angle direction of 45°, a second group of branch portions 512b2 extending in an azimuthal angle direction of 135°, a third group of branch portions 512b3 extending in an azimuthal angle direction of 225°, and a fourth group of branch portions 512b4 extending in an azimuthal angle direction of 315°.

The plurality of slits 512c each extend in the same direction as the branch portion 512b adjacent thereto. Specifically, the slits 512c between the branch portions 512b1 of the first group extend in the azimuthal angle direction of 45°, and the slits 512c between the branch portions 512b2 of the second group extend in the azimuthal angle direction of 135°. The slits 512c between the branch portions 512b3 of the third group extend in the azimuthal angle direction of 225°, and the slits 512c between the branch portions 512b4 of the fourth group extend in the azimuthal angle direction of 315°.

In the presence of a voltage, an oblique electric field generated in each slit (i.e., an area of the pixel electrode 512 where a conductive film does not exist) 512c defines the azimuth in which the liquid crystal molecules are inclined (azimuthal angle component of a longer axis of the liquid crystal molecules inclined by the electric field). This azimuth is parallel to the branch portions 512b (i.e., parallel to the slits 512c) and is directed to the trunk portion 512a (i.e., different by 180° from an azimuth in which the branch portions 512b1 extend). Specifically, the azimuthal angle of the inclining azimuth defined by the branch portions 512b1 of the first group (first azimuth: arrow A) is about 225°. The azimuthal angle of the inclining azimuth defined by the branch portions 512b2 of the second group (second azimuth: arrow B) is about 315°. The azimuthal angle of the inclining azimuth defined by the branch portions 512b3 of the third group (third azimuth: arrow C) is about 45°. The azimuthal angle of the inclining azimuth defined by the branch portions 512b4 of the fourth group (fourth azimuth: arrow D) is about 135°. The above-mentioned four azimuths A through D are the azimuths of the directors of the liquid crystal domains in the 4D structure, which is formed when a voltage is applied. The azimuths A through D are generally parallel to any one of the plurality of branch portions 512b and have an angle of about 45° with respect to the polarization axes P1 and P2 of the pair of polarizing plates. A difference between any two azimuths among the azimuths A through D is approximately equal to an integral multiple of 90°, and the azimuths of the directors of the liquid crystal domains which are adjacent to each other with the trunk portion 512a interposed therebetween (e.g., the azimuths A and B) are different from each other by about 90°.

As described above, in the presence of a voltage, the liquid crystal molecules are aligned in directions having an angle of about 45° with respect to the polarization axes P1 and P2, namely, the azimuthal angle directions of 45°, 135°, 225° and 315°. Thus, the 4D structure is formed in each pixel.

### CITATION LIST

### Patent Literature

Patent Document 1: Japanese Laid-Open Patent Publication No. 11-242225

Patent Document 2: Japanese Laid-Open Patent Publication No. 2002-357830

Patent Document 3: Japanese Laid-Open Patent Publication No. 2003-149647

Patent Document 4: Japanese Laid-Open Patent Publication No. 2006-78968

Patent Document 5: Japanese Laid-Open Patent Publication No. 2003-177418

Patent Document 6: Japanese Laid-Open Patent Publication No. 2003-287753

Patent Document 7: Japanese Laid-Open Patent Publication No. 2006-330638

### SUMMARY OF INVENTION

### Technical Problem

However, as can be seen from FIG. 23, a gap between one pixel electrode 512 and another pixel electrode 512 adjacent thereto extends in a direction generally parallel to, or generally perpendicular to, the polarization axes P1 and P2. Therefore, the liquid crystal molecules in the vicinity of an outer edge of the pixel (pixel edge) are aligned in directions perpendicular to the direction in which such gaps extend, namely, in the azimuthal angle directions of 0°, 90°, 180° and 270° by oblique electric fields generated in the gaps. In other words, the liquid crystal molecules in the vicinity of the pixel edge are aligned in azimuths different from the azimuths of the directors of the liquid crystal domains. As can be seen, the alignment azimuths of the liquid crystal molecules are shifted in the vicinity of the pixel edge, and such a shift (hereinafter, referred to as the “azimuthal angle shift”) influences and thus lowers the transmittance.

FIG. 25(a) is a microphotograph of one pixel in the presence of a voltage. As can be seen from FIG. 25(a), the luminance is lowered (i.e., the transmittance is lowered) due to the azimuthal angle shift in the vicinity of the pixel edge. FIG. 25(b) is taken after the polarization axes P1 and P2 of the pair of polarizing plates in the structure shown in FIG. 25(a) are rotated by 45°. In the case where the polarization axes P1 and P2 are located in this manner, an area in which the liquid crystal molecules are aligned in desired azimuths (azimuths A through D) owing to the fishbone structure appears dark because such an area does not give any retardation to the incident light. As shown in FIG. 25(b), light leaks in the vicinity of the pixel edge, which indicates that the azimuthal angle shift occurs. Needless to say, the locations of the polarization axes P1 and P2 in FIG. 25(b) are provided so that it is easily understood that the azimuthal angle shift has occurred, and display cannot be provided with such locations of the polarization axes P1 and P2.

When the azimuthal angle shift occurs, the viewing angle dependence of the γ characteristic is deteriorated. The “γ characteristic” is the gray scale dependence of the display luminance, and the “viewing angle dependence of the γ characteristic” is a problem that the γ characteristic obtained when the display is seen from the front direction and the γ characteristic obtained when the display is seen in an oblique direction are different. Specifically, the deterioration of the viewing angle dependence of the γ characteristic, which is caused by the azimuthal angle shift, is visually recognized as a phenomenon that the γ characteristic obtained when the display is seen in an oblique direction is significantly shifted upward and the colors of the display are faded (referred to as the “washout” or “color shift”).

FIG. 26, FIG. 27 and FIG. 28 show alignment profiles of the upper left area of the pixel (area in which the branch portions 512b1 of the first group are located), which were found by calculations. FIG. 26 is a graph showing the relationship between the distance X (μm) from the pixel edge and the alignment azimuth φ(°) of the liquid crystal molecules. FIG. 27 and FIG. 28 show the alignment azimuths of liquid crystal molecules 541a in the vicinity of the pixel edge (X=0 μm), liquid crystal molecules 541b in the vicinity of the trunk portion 512a (X=30 μm), and liquid crystal molecules 541c located in an intermediate area therebetween (X=15 μm). The calculations were made with the settings that the width of the trunk portion 512a is 5 μm, the width of the branch portion 512b is 3 μm, the gap between the branch portions 512b adjacent each other is 3 μm, and the gap between the pixel electrodes 512 adjacent each other is 8 μm.

As can be seen from FIG. 26, FIG. 27 and FIG. 28, the alignment azimuth φ of the liquid crystal molecules 541c in the intermediate area is 225°. This azimuth is parallel to the slits 512c and is directed to the trunk portion 512a (i.e., different by 180° from an azimuth in which the branch portions 512b extend). By contrast, the alignment azimuth φ of the liquid crystal molecules 541a in the vicinity of the pixel edge is significantly shifted toward the horizontal azimuth (toward the azimuthal angle direction of 180°). The alignment azimuth φ of the liquid crystal molecules 541b in the vicinity of the trunk portion 512a is significantly shifted toward the vertical azimuth (toward the azimuthal angle direction of 270°). As can be seen, the azimuthal angle shift occurs in the vicinity of the pixel edge and also in the vicinity of the trunk portion 512a. The shift amount in the vicinity of the pixel edge is larger than the shift amount in the vicinity of the trunk portion 512a. In the example of FIG. 26, the maximum shift amount in the vicinity of the trunk portion 512a is +20°, whereas the maximum shift amount in the vicinity of the pixel edge is −35°. An area in which the shift amount is 5° or greater is about 5 μm in the vicinity of the trunk portion 512a, whereas such an area is about 11 μm in the vicinity of the pixel edge. From this, it is understood that the influence of the azimuthal angle shift in the vicinity of the pixel edge is exerted more internally into the liquid crystal domains of the 4D structure. Accordingly, by suppressing the occurrence of the azimuthal angle shift in the vicinity of the pixel edge, the reduction of the transmittance and the deterioration of the viewing angle dependence of the γ characteristic can be effectively prevented.

The present invention, made in the above-described problem, has an object of suppressing the occurrence of an azimuthal angle shift in the vicinity of the pixel edge in a liquid crystal display device using pixel electrodes having a fishbone structure as well as the PSA technology.

### Solution to Problem

A liquid crystal display device according to the present invention is a liquid crystal display device including a plurality of pixels and a pair of polarizing plates located in crossed Nicols and providing display in a normally black mode. Each of the plurality of pixels includes a liquid crystal layer containing liquid crystal molecules having a negative dielectric anisotropy; a pixel electrode and a counter electrode facing each other with the liquid crystal layer interposed therebetween; a pair of vertical alignment films respectively provided between the pixel electrode and the liquid crystal layer and between the counter electrode and the liquid crystal layer; and a pair of alignment sustaining layers respectively provided on surfaces of the pair of vertical alignment films on the liquid crystal layer side and formed of a photopolymerizable material. The pixel electrode includes a cross-shaped trunk portion located so as to overlap polarization axes of the pair of polarizing plates, a plurality of branch portions extending from the trunk portion in a direction having an angle of about 45° with respect thereto, and a plurality of slits formed between the plurality of branch portions; the pixel electrode has an overall shape which is a generally parallelogram shape with four right angles, each of four sides of which has an angle of about 45° with respect to the polarization axes of the pair of polarizing plates; and the plurality of branch portions are located generally symmetrically with respect to the trunk portion.

In a preferable embodiment, the liquid crystal display device according to the present invention includes a first substrate including the pixel electrode and a second substrate including the counter electrode. The first substrate further includes a switching element electrically connected to the pixel electrode, a scanning line for supplying a scanning signal to the switching element, and a signal line for supplying an image signal to the switching element; and at least one of the scanning line and the signal line extends in a direction having an angle of about 45° with respect to the polarization axes of the pair of polarizing plates, and is located between the pixel electrodes adjacent to each other.

In a preferable embodiment, both of the scanning line and the signal line extend in a direction having an angle of about 45° with respect to the polarization axes of the pair of polarizing plates, and are located between the pixel electrodes adjacent to each other.

In a preferable embodiment, the liquid crystal display device according to the present invention includes a first substrate including the pixel electrode and a second substrate including the counter electrode. The first substrate further includes a switching element electrically connected to the pixel electrode, a scanning line for supplying a scanning signal to the switching element, and a signal line for supplying an image signal to the switching element; and at least one of the scanning line and the signal line extends in a direction generally parallel to, or generally perpendicular to, the polarization axis of one of the pair of polarizing plates, and is located so as to overlap the trunk portion of the pixel electrode.

In a preferable embodiment, both of the scanning line and the signal line extend in a direction generally parallel to, or generally perpendicular to, the polarization axis of one of the pair of polarizing plates, and are located so as to overlap the trunk portion of the pixel electrode.

In a preferable embodiment, the first substrate further includes a storage capacitance line; and the storage capacitance line includes a first portion extending in a direction having an angle of about 45° with respect to the polarization axes of the pair of polarizing plates and a second portion extending in a direction generally perpendicular to the first portion, and is located between the pixel electrodes adjacent to each other.

In a preferable embodiment, one of the scanning line and the signal line extends in a direction generally parallel to, or generally perpendicular to, the polarization axis of one of the pair of polarizing plates, and is located so as to overlap the trunk portion of the pixel electrode; and the other of the scanning line and the signal line includes a first portion extending in a direction having an angle of about 45° with respect to the polarization axes of the pair of polarizing plates and a second portion extending in a direction generally perpendicular to the first portion, and is located between the pixel electrodes adjacent to each other.

In a preferable embodiment, the first substrate further includes a storage capacitance line; the signal line extends in a direction generally parallel to, or generally perpendicular to, the polarization axis of one of the pair of polarizing plates, and is located so as to overlap the trunk portion of the pixel electrode; the scanning line includes a first portion extending in a direction having an angle of about 45° with respect to the polarization axes of the pair of polarizing plates and a second portion extending in a direction generally perpendicular to the first portion, and is located between the pixel electrodes adjacent to each other; and the storage capacitance line extends in a direction generally perpendicular to the signal line, and is located so as to overlap the trunk portion of the pixel electrode.

In a preferable embodiment, the first substrate further includes a storage capacitance line and a storage capacitance electrode electrically connected to the storage capacitance line; and the storage capacitance electrode is cross-shaped and is located so as to overlap the trunk portion.

In a preferable embodiment, at least one of the storage capacitance line and the storage capacitance electrode is formed of a transparent conductive material.

In a preferable embodiment, both of the storage capacitance line and the storage capacitance electrode are formed of a transparent conductive material.

In a preferable embodiment, circular polarization is incident on the liquid crystal layer, and display is provided by the liquid crystal layer modifying the circular polarization.

In a preferable embodiment, the liquid crystal display device according to the present invention includes a first phase plate located between one of the pair of polarizing plates and the liquid crystal layer, and a second phase plate located between the other of the pair of polarizing plates and the liquid crystal layer.

In a preferable embodiment, the first phase plate is a λ/4 plate having a delay axis which has an angle of about 45° with respect to the polarization axis of the one of the pair of polarization axes; and the second phase plate is a λ/4 plate having a delay axis generally perpendicular to the delay axis of the first phase plate.

In a preferable embodiment, when a voltage is applied between the pixel electrode and the counter electrode, four liquid crystal domains are formed in the liquid crystal layer in each of the plurality of pixels; four directors respectively representative of alignment directions of the liquid crystal molecules in the four liquid crystal domains have different azimuths from one another; and each of the azimuths of the four directors has an angle of about 45° with respect to the polarization axes of the pair of polarizing plates.

In a preferable embodiment, the four liquid crystal domains are a first liquid crystal domain in which the azimuth of the director is a first azimuth, a second liquid crystal domain in which the azimuth of the director is a second azimuth, a third liquid crystal domain in which the azimuth of the director is a third azimuth, and a fourth liquid crystal domain in which the azimuth of the director is a fourth azimuth; and a difference between any two azimuths among the first azimuth, the second azimuth, the third azimuth and the fourth azimuth is approximately equal to an integral multiple of 90°; and the azimuths of the directors of the liquid crystal domains adjacent to each other with the trunk portion interposed therebetween are different from each other by about 90°.

### Advantageous Effects of Invention

According to the present invention, in a liquid crystal display device using pixel electrodes having a fishbone structure as well as the PSA technology, the occurrence of an azimuthal angle shift in the vicinity of the pixel edge can be suppressed.

### BRIEF DESCRIPTION OF DRAWINGS

FIGS. 1(a) and (b) schematically show a liquid crystal display device 100 in a preferable embodiment according to the present invention; FIG. 1(a) is a plan view, and FIG. 1(b) is a cross-sectional view taken along line 1B-1B′ in FIG. 1(a).

FIG. 2 is a plan view schematically showing a pixel electrode 12 included in the liquid crystal display device 100.

FIG. 3 schematically shows alignment of liquid crystal molecules 41 in the vicinity of the pixel edge in the liquid crystal display device 100.

FIG. 4 is a graph showing the relationship between the distance X (μm) from the pixel edge and the alignment azimuth φ(°) of the liquid crystal molecules 41.

FIG. 5(a) is a graph showing the relationship between the display gray scale and the transmission intensity (γ characteristic) in a conventional liquid crystal display device 500, and FIG. 5(b) is a graph showing the relationship between the display gray scale and the transmission intensity (γ characteristic) in the liquid crystal display device 100.

FIGS. 6(a) and (b) are plan views schematically showing the liquid crystal display device 100.

FIG. 7 schematically shows the alignment azimuths in the case where the azimuthal angle shift does not occur.

FIG. 8 schematically shows the alignment azimuths in the case where the azimuthal angle shift occurs uniformly in the vicinity of a trunk portion 12a of the pixel electrode 12.

FIG. 9 schematically shows the alignment azimuths in the case where the azimuthal angle shift occurs nonuniformly in the vicinity of the trunk portion 12a of the pixel electrode 12.

FIG. 10 is a graph showing the γ characteristic assumed from the alignment state shown in FIG. 7.

FIG. 11 is a graph showing the γ characteristic assumed from the alignment state shown in FIG. 8.

FIG. 12 is a graph showing the γ characteristic assumed from the alignment state shown in FIG. 9.

FIGS. 13(a) and (b) schematically show the liquid crystal display device 100; FIG. 13(a) is a plan view, and FIG. 13(b) is a cross-sectional view taken along line 13B-13B′ in FIG. 13(a).

FIGS. 14(a) and (b) schematically show the liquid crystal display device 100; FIG. 14(a) is a plan view, and FIG. 14(b) is a cross-sectional view taken along line 14B-14B′ in FIG. 14(a).

FIGS. 15(a) and (b) schematically show a liquid crystal display device 200 in a preferable embodiment according to the present invention; FIG. 15(a) is a plan view, and FIG. 15(b) is a cross-sectional view taken along line 15B-15B′ in FIG. 15(a).

FIGS. 16(a) and (b) schematically show the liquid crystal display device 200; FIG. 16(a) is a plan view, and FIG. 16(b) is a cross-sectional view taken along line 16B-16B′ in FIG. 16(a).

FIGS. 17(a) and (b) schematically show the liquid crystal display device 200; FIG. 17(a) is a plan view, and FIG. 17(b) is a cross-sectional view taken along line 17B-17B′ in FIG. 17(a).

FIGS. 18(a) and (b) schematically show a liquid crystal display device 300 in a preferable embodiment according to the present invention; FIG. 18(a) is a plan view, and FIG. 18(b) is a cross-sectional view taken along line 18B-18B′ in FIG. 18(a).

FIG. 19(a) schematically shows a cross-sectional structure of the liquid crystal display devices 100 through 300, and FIGS. 19(b) and (c) each schematically show a polarization state of light passing the inside of the liquid crystal display devices 100 through 300; FIG. 19(b) corresponds to a black display state (in the absence of a voltage), and FIG. 19(c) corresponds to a white display state (in the presence of a voltage).

FIG. 20(a) schematically shows a liquid crystal display devices 400 in a preferable embodiment according to the present invention, and FIGS. 20(b) and (c) each schematically show a polarization state of light passing the inside of the liquid crystal display device 400; FIG. 20(b) corresponds to a black display state (in the absence of a voltage), and FIG. 20(c) corresponds to a white display state (in the presence of a voltage).

FIG. 21 shows the transmission characteristic of one pixel in the liquid crystal display device 100 (adopting a structure using linear polarization) in the presence of a voltage.

FIG. 22 shows the transmission characteristic of one pixel in the liquid crystal display device 400 (adopting a structure using circular polarization) in the presence of a voltage.

FIG. 23 is a plan view schematically showing the conventional liquid crystal display device 500 including pixel electrodes 512 having a fishbone structure.

FIG. 24 schematically shows the relationship between the fishbone structure of the pixel electrodes 512 and the azimuths of directors of liquid crystal domains.

FIG. 25(a) is a microphotograph showing one pixel in the liquid crystal display device 500 in the presence of a voltage; and FIG. 25(b) is taken after polarization axes P1 and P2 in FIG. 25(a) are rotated by 45°.

FIG. 26 is a graph showing the relationship between the distance X (μm) from the pixel edge and the alignment azimuth φ(°) of the liquid crystal molecules.

FIG. 27 shows the alignment azimuths of liquid crystal molecules 541a in the vicinity of the pixel edge, liquid crystal molecules 541b in the vicinity of the trunk portion, and liquid crystal molecules 541c located in an intermediate area therebetween.

FIG. 28 shows the alignment azimuths of the liquid crystal molecules 541a in the vicinity of the pixel edge, the liquid crystal molecules 541b in the vicinity of the trunk portion, and the liquid crystal molecules 541c located in the intermediate area therebetween.

### DESCRIPTION OF EMBODIMENTS

Hereinafter, the present invention will be described by way of embodiments with reference to the drawings. The present invention is not limited to the following embodiments.

### Embodiment 1

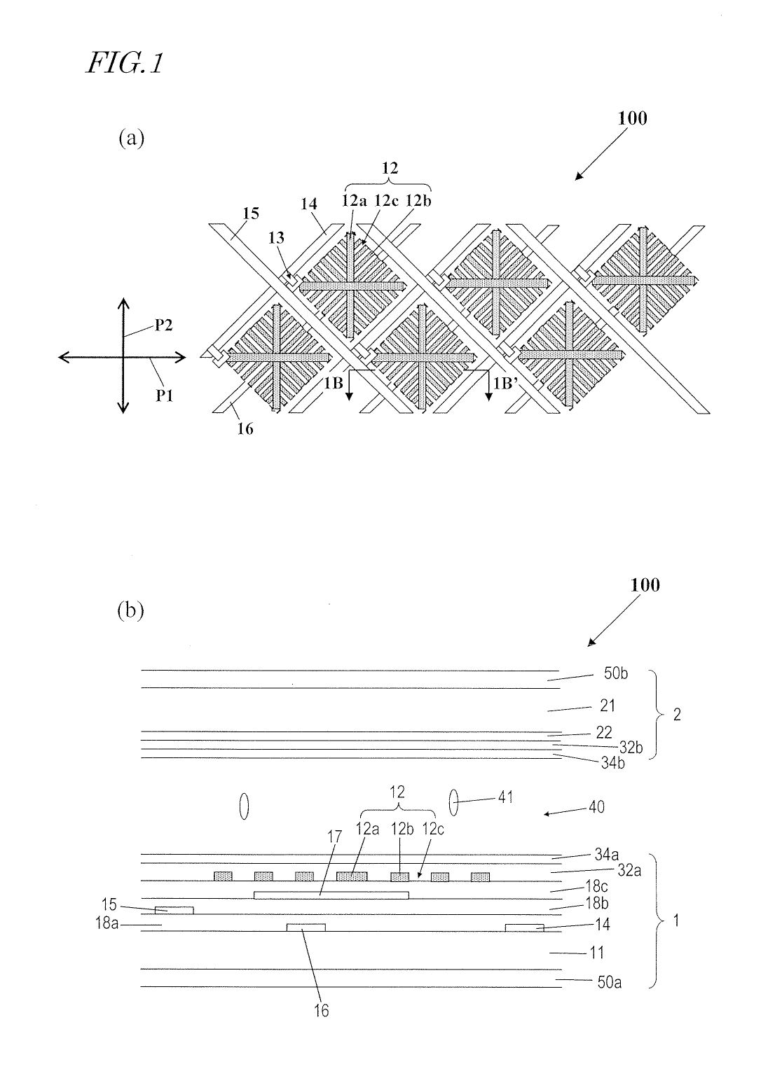

FIGS. 1(a) and (b) show a liquid crystal display device 100 in this embodiment. FIG. 1(a) is a plan view schematically showing the liquid crystal display device 100, and FIG. 1(b) is a cross-sectional view taken along line 1B-1B′ in FIG. 1(a).

The liquid crystal display device 100 includes a plurality of pixels and a pair of polarizing plates 50a and 50b located in crossed Nicols, and provides display in a normally black mode.

Each of the plurality of pixels in the liquid crystal display device 100 includes a liquid crystal layer 40, and a pixel electrode 12 and a counter electrode 22 facing each other with the liquid crystal layer 40 interposed therebetween. The liquid crystal layer 40 contains liquid crystal molecules 41 having a negative dielectric anisotropy. The pixel electrode 12 has a fishbone structure (minute striped pattern) as described later.

A pair of vertical alignment films 32a and 32b are provided respectively between the pixel electrode 12 and the liquid crystal layer 40 and between the counter electrode 22 and the liquid crystal layer 40. On surfaces of the vertical alignment films 32a and 32b on the liquid crystal layer 40 side, a pair of alignment sustaining layers 34a and 34b formed of a photopolymerizable material are provided.

The alignment sustaining layers 34a and 34b are formed by, after forming a liquid crystal cell, polymerizing the photopolymerizable compound (typically, a photopolymerizable monomer) mixed in a liquid crystal material in advance in the state where the liquid crystal layer 40 is supplied with a voltage. The alignment of the liquid crystal molecules 41 contained in the liquid crystal layer 40 is regulated by the vertical alignment films 32a and 32b until the photopolymerizable compound is polymerized. When a sufficiently high voltage (e.g., white display voltage) is applied to the liquid crystal layer 40, the liquid crystal molecules 41 are inclined in prescribed azimuths by oblique electric fields generated by the fishbone structure of the pixel electrode 12. The alignment sustaining layers 34a and 34b act to maintain (store) the alignment of the liquid crystal molecules 41 realized in the state where the liquid crystal layer 40 is provided with a voltage, even after the voltage is removed (in the absence of a voltage). Accordingly, the pretilt azimuths of the liquid crystal molecules 41 (azimuths in which the liquid crystal molecules 41 are inclined in the absence of a voltage) defined by the alignment sustaining layers 34a and 34b match the azimuths in which the liquid crystal molecules 41 are inclined in the presence of a voltage.

The liquid crystal display device 100 includes an active matrix substrate (hereinafter, referred to as the “TFT substrate”) 1 including the pixel electrodes 12, and a counter substrate (hereinafter, referred to as the “color filter substrate”) 2 including the counter electrode 22.

The TFT substrate 1 includes, in addition to the pixel electrodes 12, a transparent plate (e.g., a glass plate or a plastic plate) 11, thin film transistors (TFTs) 13 as switching elements electrically connected to the pixel electrodes 12, scanning lines 14 for supplying a scanning signal to the TFTs 13, and signal lines 15 for supplying an image signal to the TFTs 13. The TFT substrate 1 further includes storage capacitance lines 16 and storage capacitance electrodes 17 electrically connected to the storage capacitance lines 16.

The scanning lines 14 and the storage capacitance lines 16 are formed on a surface of the transparent plate 11 on the liquid crystal layer 40 side. A first insulating layer 18a is formed so as to cover the scanning lines 14 and the storage capacitance lines 16. On the first insulating layer 18a, a semiconductor layer (not shown) acting as channel regions, source regions and drain regions of the TFTs 13 and the signal lines 15 are formed. A second insulating layer 18b is formed so as to cover the signal lines 15 and the like. On the second insulating layer 18b, the storage capacitance electrodes 17 are formed. A third insulating layer 18c is formed so as to cover the storage capacitance electrodes 17. On the third insulating layer 18c, the pixel electrodes 12 are formed. On a surface of the transparent plate 11 opposite to the liquid crystal layer 40, the polarizing plate 50a is provided.

The counter substrate 2 includes, in addition to the counter electrode 22, a transparent plate (e.g., a glass plate or a plastic plate) 21 and color filters (not shown). The counter electrode 22 is formed on a surface of the transparent plate 21 on the liquid crystal layer 40 side. On a surface of the transparent plate 21 opposite to the liquid crystal layer 40, the polarizing plate 50b is provided.

As described above, the pair of polarizing plates 50a and 50b are located in crossed Nicols. Namely, as shown in FIG. 1(a), the polarization axis (transmission axis) P1 of the polarizing plate 50a and the polarization axis (transmission axis) P2 of the polarizing plate 50b are perpendicular to each other.

In the liquid crystal display device 100 in this embodiment, each pixel electrode 12 includes a cross-shaped trunk portion 12a located so as to overlap the polarization axes P1 and P2 of the pair of polarizing plates 50a and 50b, a plurality of branch portions 12b extending from the trunk portion 12a in a direction having an angle of about 45° with respect thereto, and a plurality of slits 12c formed between the plurality of branch portions 12b. In the liquid crystal display device 100, each pixel electrode 12 has a fishbone structure (minute striped pattern) as described above, and thus is divided into domains of different alignment directions. Namely, when a voltage is applied between the pixel electrode 12 and the counter electrode 22, four (four types of) liquid crystal domains are formed in the liquid crystal layer 40 in each pixel. Four directors respectively representative of the alignment directions of the liquid crystal molecules 41 contained in the four liquid crystal domains have different azimuths from each other. Therefore, the azimuthal angle dependence of the viewing angle is lowered, and a display of a wide viewing angle is realized.

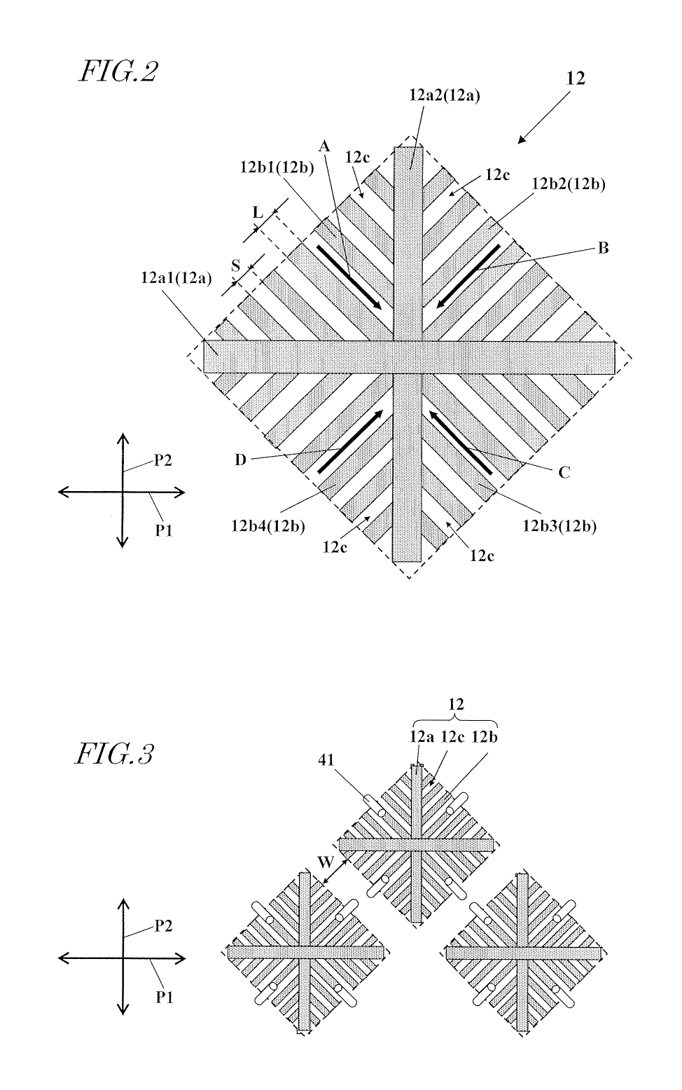

Hereinafter, with reference also to FIG. 2, a more detailed structure of the pixel electrode 12, and the relationship between the structure and the azimuths of the directors in the liquid crystal domains, will be described. FIG. 2 is a plan view showing one pixel electrode in enlargement.

The trunk portion 12a of the pixel electrode 12 includes a linear portion (horizontal linear portion) 12a1 extending in a horizontal direction and a linear portion (vertical linear portion) 12a2 extending in a vertical direction. The horizontal linear portion 12a1 and the vertical linear portion 12a2 cross each other (perpendicularly) at the center of the pixel.

The plurality of branch portions 12b are divided into four groups corresponding to four areas separated from each other by the cross-shaped trunk portion 12a. It is now assumed that the display plane is the face of a clock, that the azimuthal angle of 0° corresponds to the 9 o'clock direction, and that the clockwise direction is a forward direction. With such assumptions, the plurality of branch portions 12b are divided into a first group of branch portions 12b1 extending in an azimuthal angle direction of 45°, a second group of branch portions 12b2 extending in an azimuthal angle direction of 135°, a third group of branch portions 12b3 extending in an azimuthal angle direction of 225°, and a fourth group of branch portions 12b4 extending in an azimuthal angle direction of 315°.

In each of the first group, the second group, the third group and the fourth group, width L of each of the plurality of branch portions 12b and gap S between the branch portions 12b adjacent to each other are typically 1.5 μm or greater and 5.0 μm or less. From the viewpoints of stability of the liquid crystal molecules 41 and the luminance, it is preferable that the width L and the gap S of the branch portion 12b are within the above-mentioned range.

The plurality of slits 12c each extend in the same direction as the branch portion 12b adjacent thereto. Specifically, the slits 12c between the branch portions 12b1 of the first group extend in the azimuthal angle direction of 45°, and the slits 12c between the branch portions 12b2 of the second group extend in the azimuthal angle direction of 135°. The slits 12c between the branch portions 12b3 of the third group extend in the azimuthal angle direction of 225°, and the slits 12c between the branch portions 12b4 of the fourth group extend in the azimuthal angle direction of 315°.

In the presence of a voltage, an oblique electric field generated in each slit (i.e., an area of the pixel electrode 12 where a conductive film does not exist) 12c defines the azimuth in which the liquid crystal molecules 41 are inclined (azimuthal angle component of a longer axis of the liquid crystal molecules 41 inclined by the electric field). This azimuth is parallel to the branch portions 12b (i.e., parallel to the slits 12c) and is directed to the trunk portion 12a (i.e., different by 180° from an azimuth in which the branch portions 12b extend). Specifically, the azimuthal angle of the inclining azimuth defined by the branch portions 12b1 of the first group (first azimuth: arrow A) is about 225°. The azimuthal angle of the inclining azimuth defined by the branch portions 12b2 of the second group (second azimuth: arrow B) is about 315°. The azimuthal angle of the inclining azimuth defined by the branch portions 12b3 of the third group (third azimuth: arrow C) is about 45°. The azimuthal angle of the inclining azimuth defined by the branch portions 12b4 of the fourth group (fourth azimuth: arrow D) is about 135°. The above-mentioned four azimuths A through D are the azimuths of the directors of the liquid crystal domains in the 4D structure, which is formed when a voltage is applied. The azimuths A through D are generally parallel to any one of the plurality of branch portions 12b and have an angle of about 45° with respect to the polarization axes P1 and P2 of the pair of polarizing plates 50a and 50b. A difference between any two azimuths among the azimuths A through D is approximately equal to an integral multiple of 90°, and the azimuths of the directors of the liquid crystal domains adjacent to each other with the trunk portion 12a interposed therebetween (e.g., the azimuths A and B) are different from each other by about 90°.

The liquid crystal display device 100 in this embodiment has a feature in the overall shape of the pixel electrode 12 including the trunk portion 12a, the branch portions 12b and the slits 12c. As shown in FIG. 1(a) and FIG. 2, the overall shape of the pixel electrode 12 is a generally parallelogram shape with four right angles (more specifically, a generally square shape), each of four sides of which has an angle of about 45° with respect to the polarization axes P1 and P2 of the pair of polarizing plates 50a and 50b. Namely, each of the sides defining the external shape of the pixel electrode 12 has an angle of about 45° with respect to the polarization axes P1 and P2. The plurality of branch portions 12b are located generally symmetrically with respect to the trunk portion 12a.

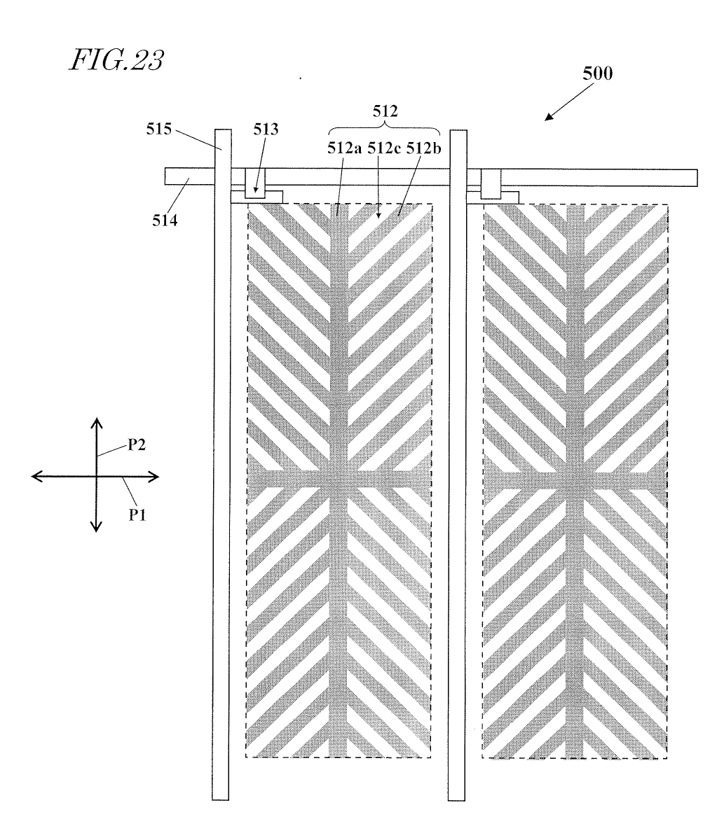

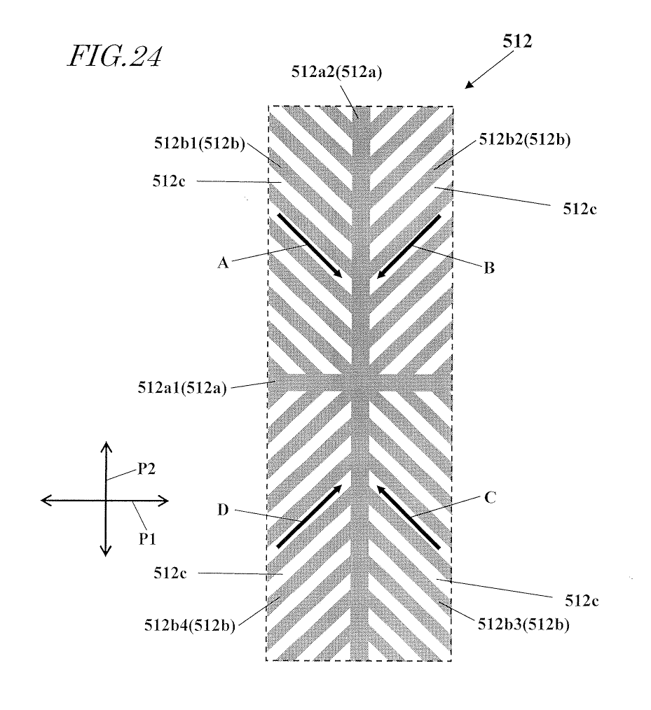

By contrast, as shown in FIG. 23 and FIG. 24, the overall shape of the pixel electrode 512 in the conventional liquid crystal display device 500 is a generally parallelogram shape with four right angles, each of four sides of which is generally parallel to, or generally perpendicular to, the polarization axes P1 and P2. Namely, each of the sides defining the external shape of the pixel electrode 512 is generally parallel to, or generally perpendicular to, the polarization axes P1 and P2.

The liquid crystal display device 100 also has a feature in the locations of the lines including the scanning lines 14. As shown in FIG. 1(a), the scanning lines 14 and the signal lines 15 extend in a direction having an angle of about 45° with respect to the polarization axes P1 and P2 of the pair of polarizing plates 50a and 50b, and are each located between the pixel electrodes 12 adjacent to each other. The storage capacitance lines 16 also extend in a direction having an angle of about 45° with respect to the polarization axes P1 and P2. However, the storage capacitance lines 16 are each located so as to pass the center of the pixel, instead of between the pixel electrode 12 adjacent to each other.

By contrast, as shown in FIG. 23, the scanning lines 514 and the signal lines 515 in the conventional liquid crystal display device 500 extend in a direction generally parallel to, or generally perpendicular to, the polarization axes P1 and P2.

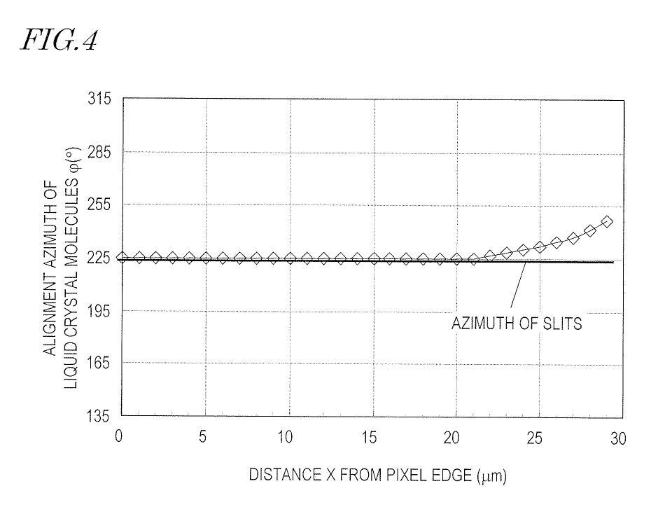

As described above, in the liquid crystal display device 100 in this embodiment, each of the sides defining the external shape of the pixel electrode 12 has an angle of about 45° with respect to the polarization axes P1 and P2. Therefore, a gap between one pixel electrode 12 and another pixel electrode 12 adjacent thereto extends in a direction having an angle of about 45° with respect to the polarization axes P1 and P2. Accordingly, as shown in FIG. 3, the liquid crystal molecules 41 in the vicinity of the pixel edge are aligned, by the oblique electric fields generated in the gaps, in directions perpendicular to the directions in which the gaps extend, namely, in azimuthal angle directions of 45°, 135°, 225° and 315°. Namely, the liquid crystal molecules 41 in the vicinity of the pixel edge are aligned in the same azimuth as the azimuths A through D of the directions of the liquid crystal domains. Hence, the occurrence of the azimuthal angle shift in the vicinity of the pixel edge is suppressed, and as a result, the reduction of the transmittance and the deterioration of the viewing angle dependence of the γ characteristic are suppressed.

In the liquid crystal display device 100 in this embodiment, the scanning lines 14 and the signal lines 15 extend in a direction having an angle of about 45° with respect to the polarization axes P1 and P2, and are each located between the pixel electrodes 12 adjacent to each other. Namely, the scanning lines 14 and the signal lines 15 are located so as not to overlap the pixel electrodes 12. The scanning lines 14 and the signal lines 15 are typically formed of an opaque metal material, but owing to the above-described locations of the scanning lines 14 and the signal lines 15, the loss of the transmittance caused by the scanning lines 14 and the signal lines 15 is reduced. The alignment caused by the electric fields which is generated by the fishbone structure is suppressed owing to the above-mentioned locations from being disturbed by electric fields leaking from the scanning lines 14 and the signal lines 15.

Width W of a gap portion between one pixel electrode 12 and another pixel electrode 12 adjacent thereto (i.e., the gap between two adjacent pixel electrodes 12, see FIG. 3) is typically 3.0 μm or greater and 10 μm or less. From the viewpoints of stability of the liquid crystal molecules 41 and the luminance, it is preferable that the width W is within the above-mentioned range.

The effect of suppressing the azimuthal angle shift provided by the liquid crystal display device 100 in this embodiment was investigated. The results will be described, hereinafter.

FIG. 4 shows the relationship between the distance X (μm) from the pixel edge and the alignment azimuth φ(°) of the liquid crystal molecules 41 in the liquid crystal display device 100 in this embodiment. FIG. 4 shows the alignment profile of the upper left area of the pixel (area in which the branch portions 12b1 of the first group are located), which was found by calculations. In the example shown in FIG. 4, the size of one pixel is 60 μm×60 μm. Namely, the distance X is 30 μm at the center of the pixel. The width L of each of the plurality of branch portions 12b is 3.0 μm, and the gap S between two adjacent branch portions 12b is 3.0 μm. The width W of the gap portion is 8.0 μm.

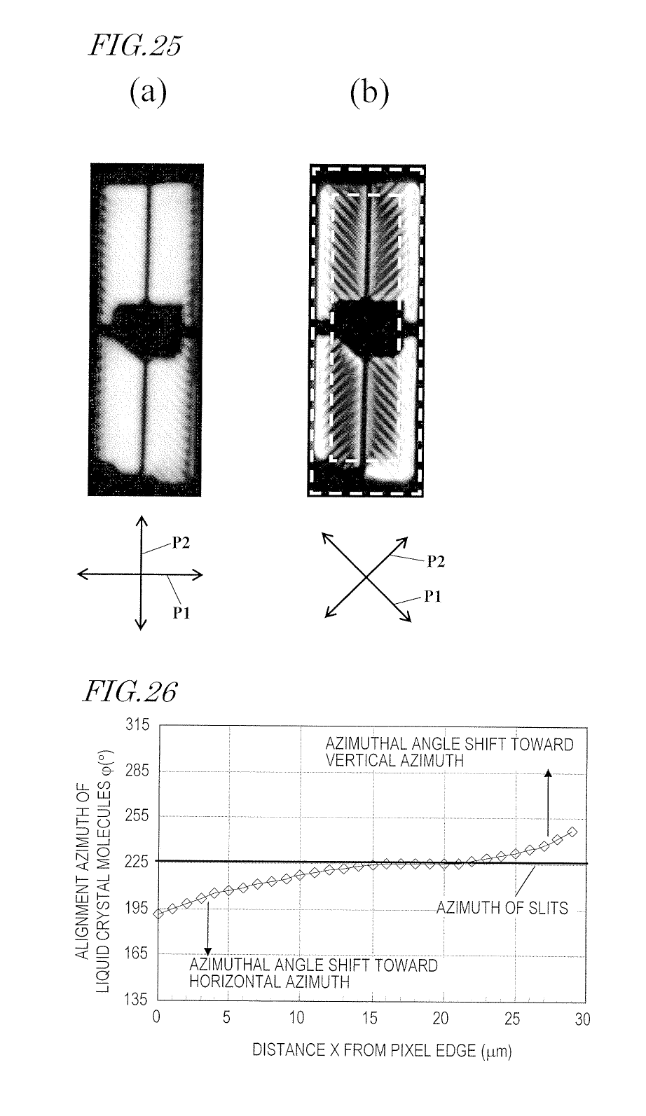

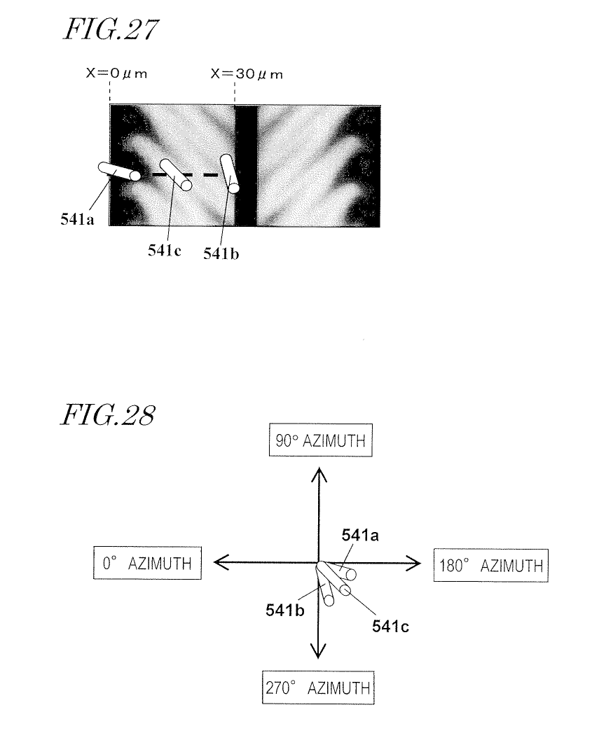

As can be seen from FIG. 4, in the vicinity of the pixel edge (X=0 μm), the alignment azimuth of the liquid crystal molecules 41 is 225°. This azimuth is parallel to the slits 12c and is directed to the trunk portion 12a (i.e., different by 180° from an azimuth in which the branch portions 12b1 extend). Namely, the alignment azimuth φ of the liquid crystal molecules 41 in the vicinity of the pixel edge is the same as the azimuth A of the director of the liquid crystal domain formed in this area. As can be seen, in the liquid crystal display device 100, the azimuthal angle shift in the vicinity of the pixel edge (significant shift toward the horizontal azimuth, i.e., toward the azimuthal angle direction of 180° as shown in FIG. 26) is suppressed.

Regarding the liquid crystal display device 100 in this embodiment and the conventional liquid crystal display device 500 shown in FIG. 23, the transmittance of the pixels was found by calculations and compared. For the calculations, the size of one pixel was set to 60 μm×60 μm in both of the liquid crystal display devices 100 and 500. Assuming that the pixel electrodes 12 and 512 are formed of a transparent oxidized metal material such as ITO, IZO or the like, the transmittance thereof was set to 100%. Assuming that the scanning lines 14 and 514 and the signal lines 15 and 515 are formed of a metal material such as Al, Mo or the like, the transmittance thereof was set to 0%. As a result of the calculations, it was found that the transmittance of the pixels of the liquid crystal display device 100 in this embodiment is about 30% higher than that of the conventional liquid crystal display device 500. As can be seen, the transmittance can be significantly improved by suppression of the azimuthal angle shift in the vicinity of the pixel edge.

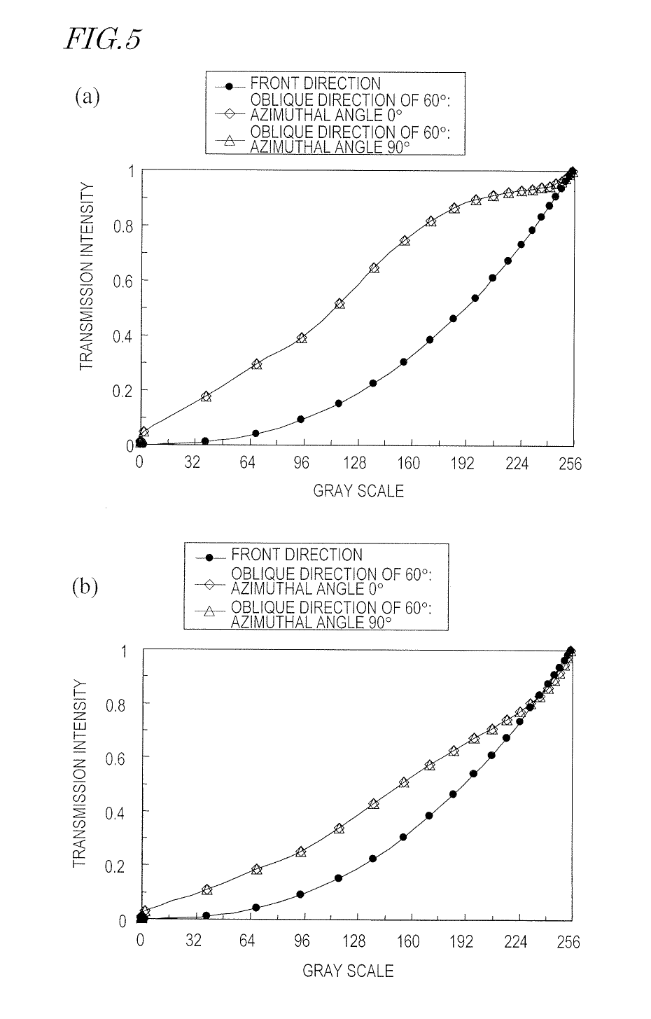

FIG. 5(a) shows the relationship between the display gray scale and the transmission intensity (i.e., γ characteristic) of the conventional liquid crystal display device 500, and FIG. 5(b) shows the γ characteristic of the liquid crystal display device 100 in this embodiment. FIGS. 5(a) and (b) show the γ characteristic provided when the display is observed from the front direction and the γ characteristic provided when the display is observed in an oblique direction of 60° at the azimuthal angle of 0° (horizontal azimuth) and at the azimuthal angle of 90° (vertical azimuth). Namely, FIGS. 5(a) and (b) show the viewing angle dependence of the γ characteristic.

As shown in FIG. 5(a), in the conventional liquid crystal display device 500, a curve representing the γ characteristic provided when the display is observed in the oblique direction is significantly shifted upward as compared with a curve representing the γ characteristic provided when the display is observed from the front direction. Namely, when the display is observed in the oblique direction, the display luminance (corresponding to the transmission intensity) is significantly higher than the proper display luminance (display luminance provided when the display is observed from the front direction). Therefore, a phenomenon that the colors of the display are faded as a whole (washout or color shift) occurs when the display is observed in the oblique direction occurs.

By contrast, as shown in FIG. 5(b), in the liquid crystal display device 100 in this embodiment, the shift amount of the γ characteristic provided when the display is observed in the oblique direction, with respect to the γ characteristic provided when the display is observed in the front direction, is smaller than that in the conventional liquid crystal display device 500, and so the upward shift of the γ characteristic is suppressed. Accordingly, the occurrence of the washout (color shift) is suppressed when the display is observed in the oblique direction.

As described above, in the liquid crystal display device 100 in this embodiment, the occurrence of the azimuthal angle shift in the vicinity of the pixel edge is suppressed, and therefore, the reduction of the transmittance and the deterioration of the viewing angle dependence of the γ characteristic, which are caused by the azimuthal angle shift, are suppressed.

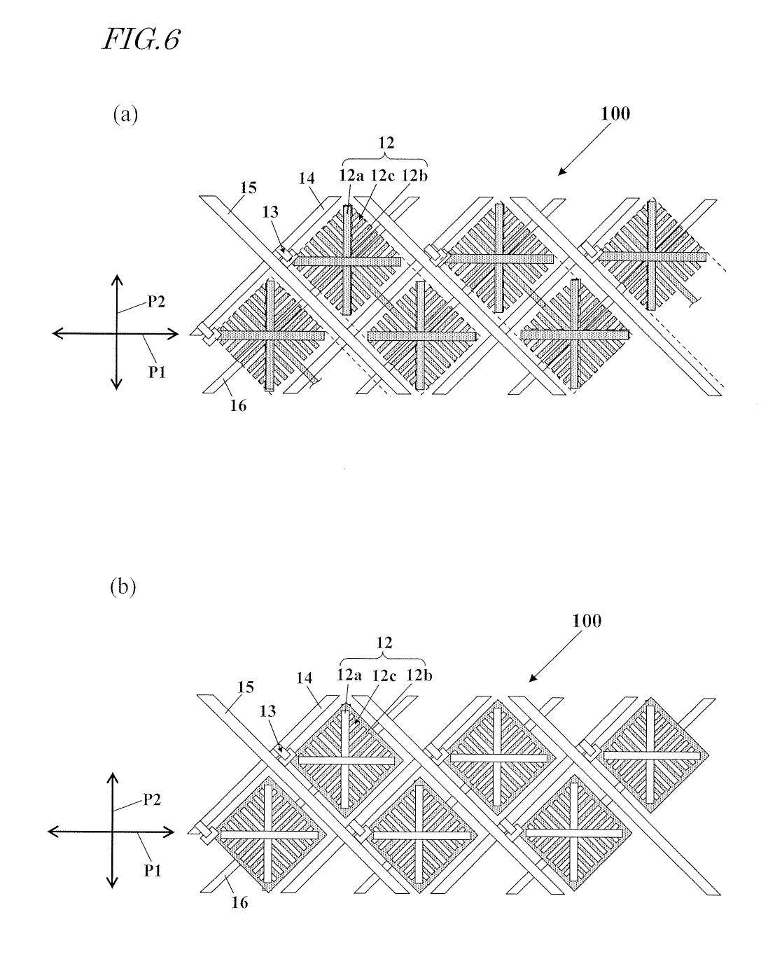

FIG. 1 and other figures show the pixel electrodes 12 having a generally square shape, but the overall shape of the pixel electrodes 12 is not limited to this. The pixel electrode 12 merely need to have a generally parallelogram shape with four right angles, each of four sides of which has an angle of about 45° with respect to the polarization axes P1 and P2. For example, as shown in FIG. 6(a), the pixel electrodes 12 may each have a generally rectangular shape including two generally square shapes connected to each other. The pixel electrodes 12 shown in FIG. 6(a) each include two cross-shaped trunk portions 12a and is generally rectangular as a whole. From each the two trunk portions 12a, a plurality of branch portions 12b extend. One of the branch portions 12b extending from one of the trunk portions 12a and one of the branch portions 12b extending from the other trunk portion 12a are connected to each other. According to the structure shown in FIG. 1, the trunk portions 12a are formed of a conductive film. Alternatively, as shown in FIG. 6(b), the trunk portions 12a may be deprived of the conductive film. Namely, the trunk portions 12a may be cross-shaped slits. In the pixel electrodes 12 shown in FIG. 6(b), the branch portions 12b and the slits 12c are located in an opposite manner from in the pixel electrodes 12 shown in FIG. 1. Namely, the pixel electrodes 12 shown in FIG. 6(b) each have a pattern in which the conductive portions and the non-conductive portions are inverted from the pixel electrodes 12 shown in FIG. 1.

As described above, in the liquid crystal display device 100 in this embodiment, the azimuthal angle shift in the vicinity of the pixel edge is suppressed. However, as can be seen from in FIG. 4, the occurrence of the azimuthal angle shift in the vicinity of the trunk portion 12a cannot be suppressed. Nonetheless, in the liquid crystal display device 100, the plurality of branch portions 12b are located generally symmetrically with respect to the trunk portion 12a (i.e., generally line-symmetrically with respect to both of the horizontal linear portion 12a1 and the vertical linear portion 12a2 of the trunk portion 12a). Where the plurality of branch portions 12b are located in this manner (and so necessarily, the plurality of slits 12c are located generally symmetrically with respect to the trunk portion 12a), the azimuthal angle shift in the vicinity of the trunk portion 12a occurs uniformly among the liquid crystal domains. Therefore, the adverse effect on the display quality can be suppressed. Hereinafter, this will be described more specifically.

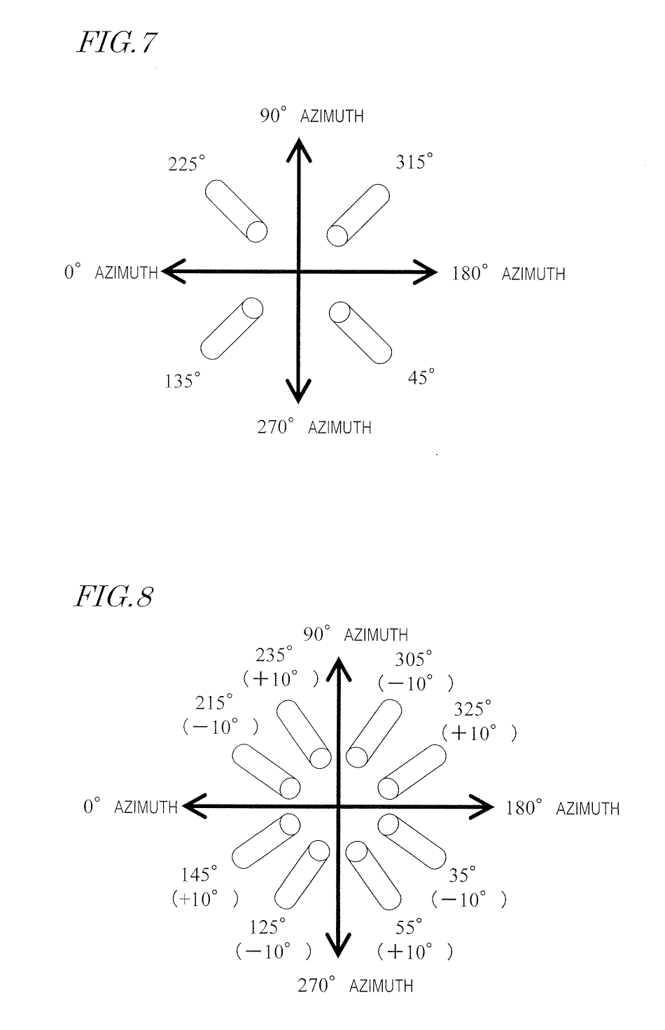

FIG. 7 schematically shows the alignment azimuths in the case where the azimuthal angle shift is assumed not to occur. FIG. 8 schematically shows the alignment azimuths in the case where the azimuthal angle shift occurs uniformly in the vicinity of the trunk portion 12a. FIG. 9 schematically shows the alignment azimuths in the case where the azimuthal angle shift occurs nonuniformly in the vicinity of the trunk portion 12a.

When the azimuthal angle shift does not occur, as shown in FIG. 7, the liquid crystal molecules in the four liquid crystal domains are aligned in the azimuthal angles of the directors, i.e., at 45°, 135°, 225° and 315°. By contrast, when the azimuthal angle shift occurs in the vicinity of the trunk portion 12a, as shown in FIG. 8 and FIG. 9, the alignment azimuths in the vicinity of the trunk portion 12a are shifted from the azimuthal angles of the directors of the respective liquid crystal domains. As shown in FIG. 8 and FIG. 9, in each of the liquid crystal domains, the alignment azimuth is shifted toward the horizontal azimuth in the vicinity of the horizontal linear portion 12a1 and toward the vertical azimuth in the vicinity of the vertical linear portion 12a2.

In the liquid crystal display device 100 in this embodiment, the plurality of branch portions 12b (and necessarily, the plurality of slits 12c) are located generally symmetrically with respect to the trunk portion 12a (at least in the vicinity of the trunk portion 12a), and the occupying ratio of the branch portions 12b (or the occupying ratio of the slits 12c) in the vicinity of the horizontal linear portion 12a1 of the trunk portion 12a is approximately equal to the occupying ratio of the branch portions 12b (or the occupying ratio of the slits 12c) in the vicinity of the vertical linear portion 12a2 of the trunk portion 12a. Therefore, as shown in FIG. 8, in each liquid crystal domain, the magnitude of the azimuthal angle shift toward the horizontal azimuth is approximately equal to the magnitude of the azimuthal angle shift toward the vertical azimuth. Hence, the azimuthal angle shift (average value) in the vicinity of the trunk portion 12a is approximately equal among the four liquid crystal domains. Thus, it is considered that the azimuthal angle shift occurs uniformly in the vicinity of the trunk portion 12a.

By contrast, where the plurality of branch portions 12b are located asymmetrically with respect to the trunk portion 12a, as shown in FIG. 9, in each liquid crystal domain, the magnitude of the azimuthal angle shift toward the horizontal azimuth is different from the magnitude of the azimuthal angle shift toward the vertical azimuth. For example, where the occupying ratio of the branch portions 12b (area size ratio with respect to the slits 12c) in the vicinity of the horizontal linear portion 12a1 of the trunk portion 12a is larger than the occupying ratio of the branch portions 12b in the vicinity of the vertical linear portion 12a2 of the trunk portion 12a, as shown in FIG. 9 as an example, the magnitude of the azimuthal angle shift toward the horizontal azimuth is larger than the magnitude of the azimuthal angle shift toward the vertical azimuth in the vicinity of the trunk portion 12a. Hence, the azimuthal angle shift (average value) in the vicinity of the trunk portion 12a is not uniform among the four liquid crystal domains. Thus, it is considered that the azimuthal angle shift occurs nonuniformly in the vicinity of the trunk portion 12a.

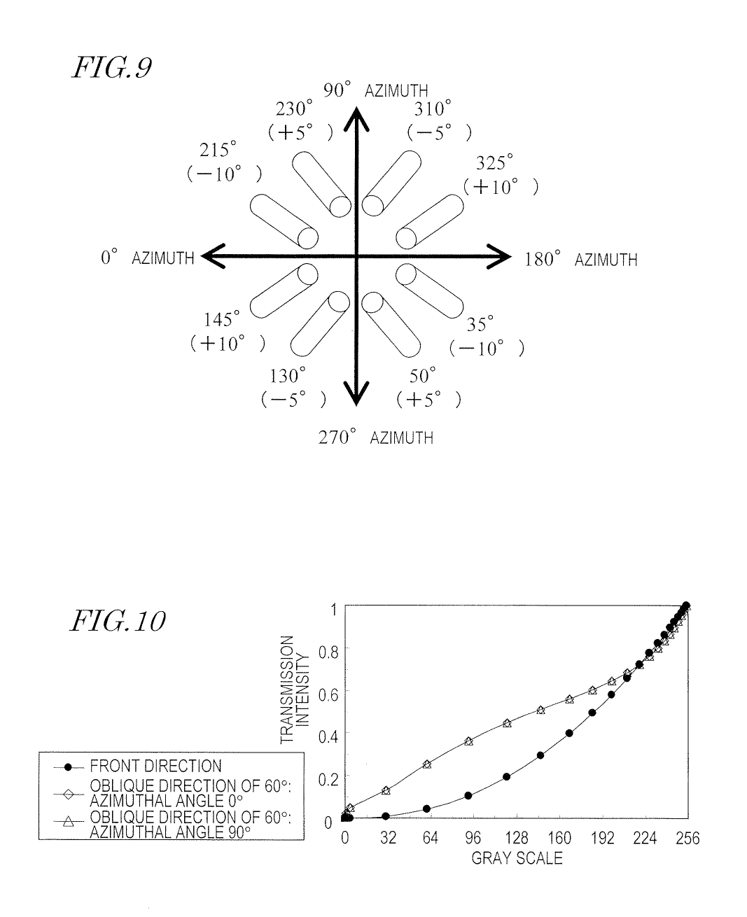

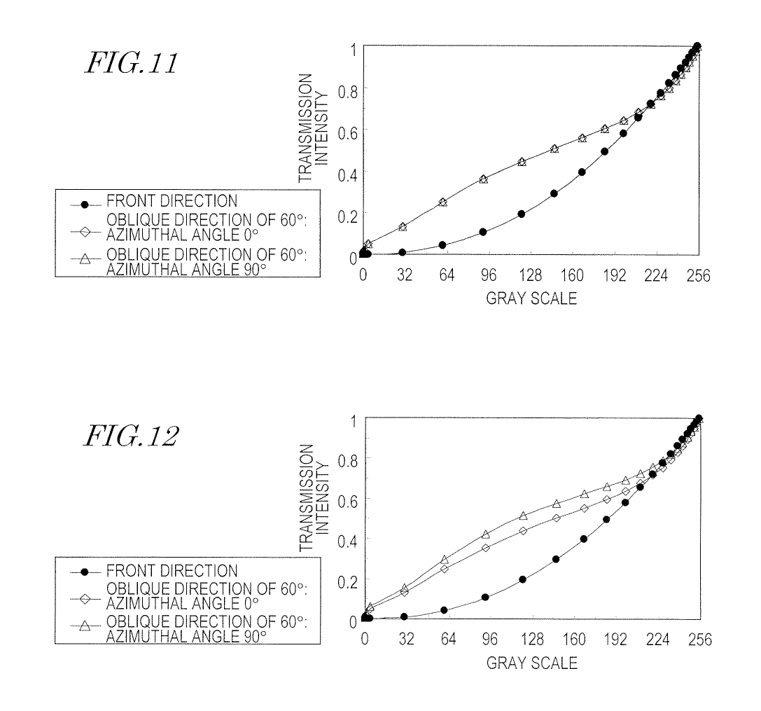

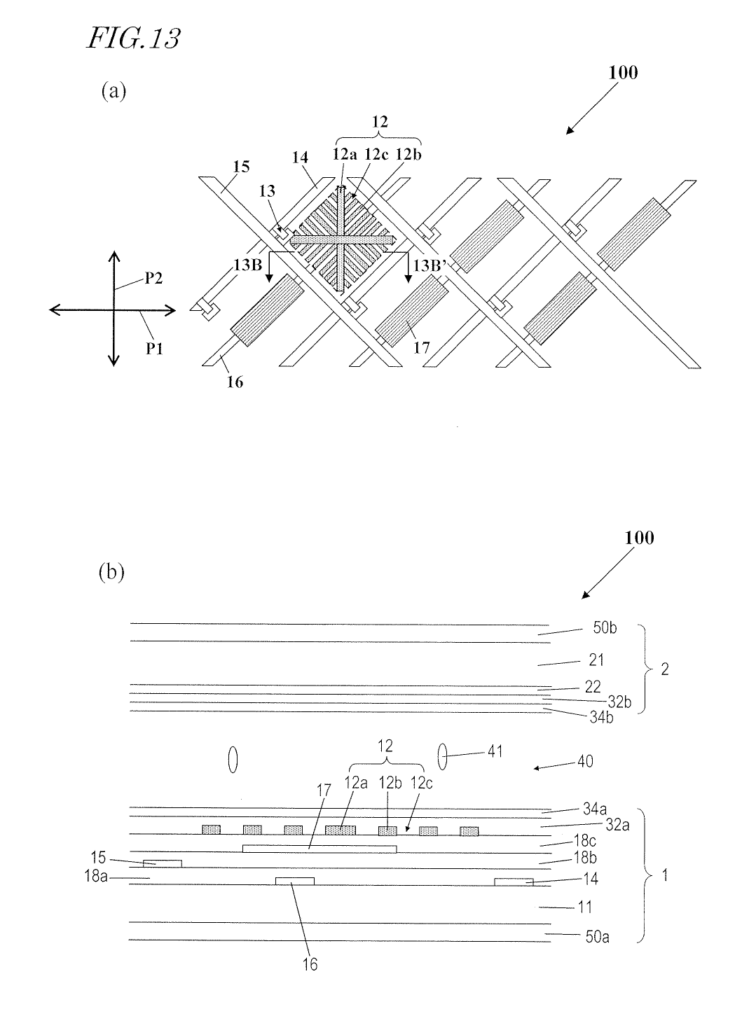

FIG. 10, FIG. 11 and FIG. 12 show the γ characteristics assumed from the alignment states shown in FIG. 7, FIG. 8 and FIG. 9, respectively. The γ characteristics were found by calculations.

As can be seen from a comparison between FIG. 10 and FIG. 11, the γ characteristic when the azimuthal angle shift is uniform in the vicinity of the trunk portion 12a (shown in FIG. 11) is approximately the same as the γ characteristic when the azimuthal angle shift does not occur (shown in FIG. 10). In this example, the calculations were made with the magnitude of the azimuthal angle shift in the vicinity of the trunk portion 12a being 10°, but the magnitude of the azimuthal angle shift (absolute value) itself is not important. As long as the magnitude of the azimuthal angle shift toward the horizontal azimuth is approximately equal to the magnitude of the azimuthal angle shift toward the vertical azimuth in each of the four liquid crystal domains, the γ characteristic is compensated for in the pixel as a whole.

As can be seen from FIG. 12, when the azimuthal angle shift is nonuniform in the vicinity of the trunk portion 12a, the γ characteristic is deteriorated at either the horizontal azimuth or the vertical azimuth (in FIG. 12, at the vertical azimuth). In this example, the calculations were made with the magnitude of the azimuthal angle shift toward the horizontal azimuth being 10° and the magnitude of the azimuthal angle shift toward the vertical azimuth being 5°, but the magnitude of the azimuthal angle shift itself is not important as described above regarding FIG. 11. When the magnitude of the azimuthal angle shift toward the horizontal azimuth is different from the magnitude of the azimuthal angle shift toward the vertical azimuth, the γ characteristic of the pixel as a whole is deteriorated at the azimuth toward which the magnitude of the azimuthal angle is smaller.

In this embodiment, both of the scanning lines 14 and the signal lines 15 extend between the pixel electrodes 12 adjacent to each other, in a direction having an angle of about 45° with respect to the polarization axes P1 and P2, but the scanning lines 14 and the signal lines 15 do not need to be located in this manner. As long as at least either the scanning lines 14 or the signal lines 15 are located as described above, the loss of the transmittance and the alignment disturbance caused by the electric fields leaking from the lines can be suppressed. Needless to say, from the viewpoint of suppressing the loss of the transmittance and the alignment disturbance caused by the leaking electric fields more certainly, it is preferable that both of the scanning lines 14 and the signal lines 15 are located as described above.

Now, a specific structure of the storage capacitance electrode 17 included in the liquid crystal display device 100 will be described. FIGS. 13(a) and (b) show an example of structure of the storage capacitance electrodes 17. In FIG. 13(a), the pixel electrodes 12 are omitted except for one pixel so that the planar shape of the storage capacitance electrodes 17 can be seen easily.

As shown in FIG. 13(a), the storage capacitance electrodes 17 each extend like a band in the same direction as the storage capacitance lines 16 (i.e., direction having an angle of about 45° with respect to the polarization axes P1 and P2). As shown in FIG. 13(b), each storage capacitance electrode 17 overlaps the trunk portion 12a and the branch portions 12b of the pixel electrode 12 with the third insulating layer 18c interposed therebetween, and thus forms a storage capacitance.

In the example shown in FIGS. 13(a) and (b), the storage capacitance electrode 17 overlaps a part of the liquid crystal domains (areas in which the liquid crystal molecules 41 are aligned in a direction having an angle of about 45° with respect to the polarization axes P1 and P2 and significantly contribute to the transmittance). Therefore, in the case where the storage capacitance electrode 17 is formed of a metal material such as Al, Mo or the like, the loss of the transmittance is large. The storage capacitance electrode also overlaps the slits 12c in addition to the trunk portion 12a and the branch portions 12b. Therefore, when a driving method of applying a voltage to the storage capacitance electrode 17 in the step of PSA processing (step of polymerizing a photopolymerizable compound in the state where the liquid crystal layer 40 is supplied with a voltage, to form the alignment sustaining layers 34a and 34b) is adopted, the alignment realized by the fishbone structure may be disturbed by the electric fields leaking from the storage capacitance electrode 17.

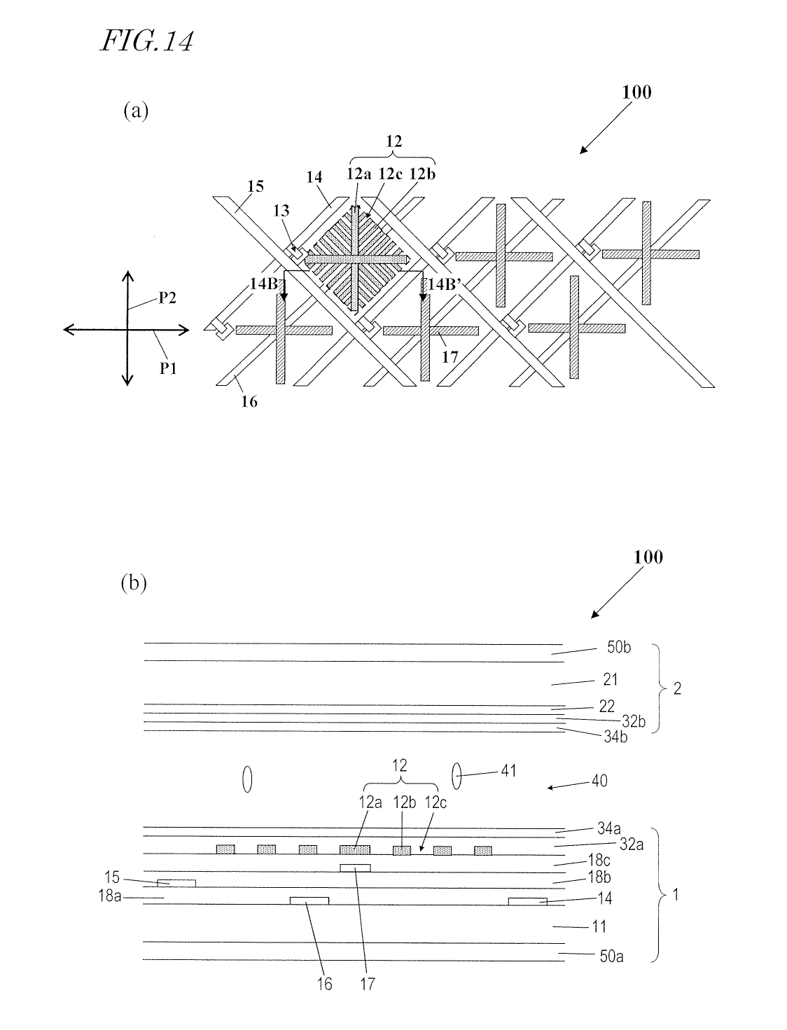

FIGS. 14(a) and (b) show another example of structure of the storage capacitance electrodes 17. In FIG. 14(a), the pixel electrodes 12 are omitted except for one pixel so that the planar shape of the storage capacitance electrodes 17 can be seen easily.

In the example shown in FIGS. 14(a) and (b), the storage capacitance electrodes 17 are each cross-shaped and located so as to overlap the trunk portion 12a of the pixel electrode 12. At such an location, the storage capacitance electrode 17 overlaps only borders between the liquid crystal domains (i.e., areas which do not contribute to the transmittance almost at all). Therefore, even though the storage capacitance electrode 17 is formed of a metal material, the loss of the transmittance is small. The storage capacitance electrode 17 overlaps the trunk portion 12a of the pixel electrode 12 and does not overlap the slits 12c. Hence, the electric fields leaking from the storage capacitance electrode 17 can be electrically shielded by the trunk portion 12a of the pixel electrode 12. Thus, the disturbance of the alignment caused by the leaking electric fields can be suppressed.

In any of the structures shown in FIG. 13 and FIG. 14, where the storage capacitance electrodes 17 are formed of a transparent conductive material, the loss of the transmittance can be reduced. Also where the storage capacitance lines 16 are formed of a transparent conductive material, the loss of the transmittance can be reduced. Namely, the transmittance can be improved by forming at least either of the storage capacitance lines 16 and the storage capacitance electrodes 17 of a transparent conductive material. Needless to say, from the viewpoint of further improving the transmittance, it is preferable that both of the storage capacitance lines 16 and the storage capacitance electrodes 17 are formed of a transparent conductive material. Specifically as the transparent conductive material, a transparent oxidized metal material such as ITO, IZO or the like is usable.

Regarding the case where the storage capacitance lines 16 and the storage capacitance electrodes 17 are formed of a metal material in the structure shown in FIG. 13 and the case where storage capacitance lines 16 and the storage capacitance electrodes 17 are formed of a transparent conductive material in the structure shown in FIG. 14, the transmittance of the pixels was found by calculations and compared. For the calculations, the size of one pixel was set to 60 μm×60 μm in both of the structures. Assuming that the pixel electrodes 12, and the storage capacitance lines 16 and the storage capacitance electrodes 17 in the structure of FIG. 14, are formed of a transparent conductive material such as ITO, IZO or the like, the transmittance thereof was set to 100%. Assuming that the scanning lines 14 and the signal lines 15, and the storage capacitance lines 16 and the storage capacitance electrodes 17 in the structure of FIG. 13, are formed of a metal material such as Al, Mo or the like, the transmittance thereof was set to 0%. As a result of the calculations, it was found that the transmittance of the pixels of the latter structure (structure of FIG. 14) is about 5% higher than that of the former structure (structure of FIG. 13).

### Embodiment 2

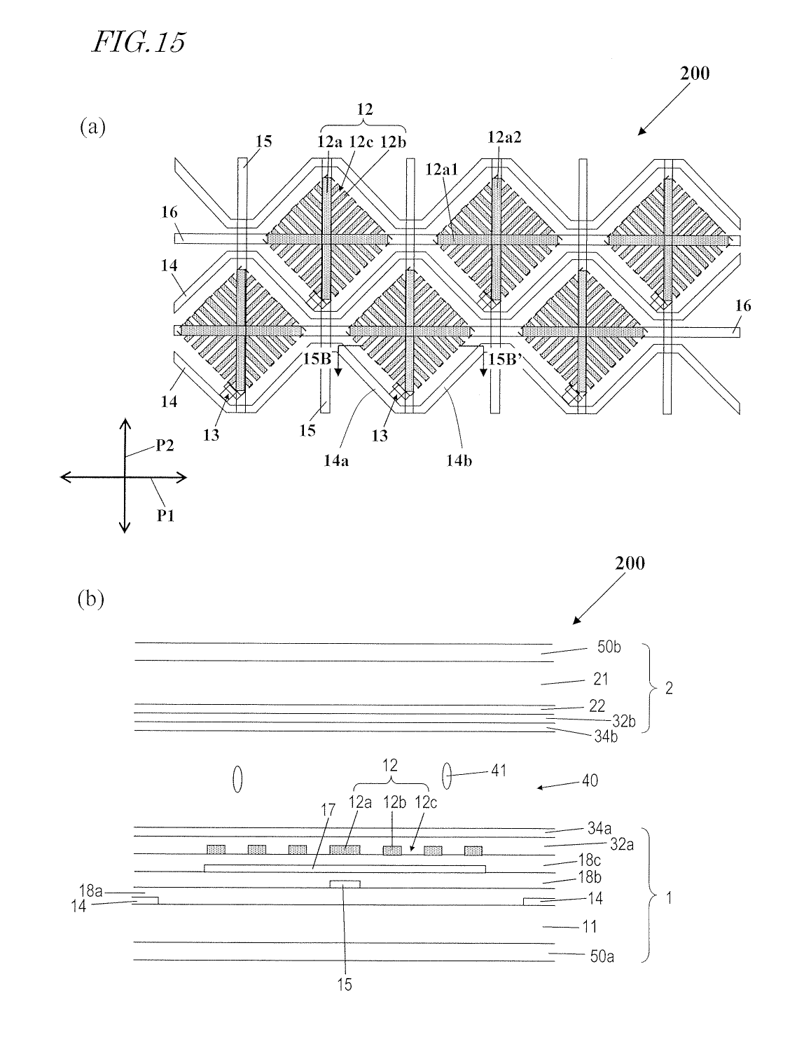

FIGS. 15(a) and (b) show a liquid crystal display device 200 in this embodiment. FIG. 15(a) is a plan view schematically showing the liquid crystal display device 200, and FIG. 15(b) is a cross-sectional view taken along line 15B-15B′ in FIG. 15(a).

Pixel electrodes 12 in the liquid crystal display device 200 in this embodiment, like the pixel electrodes 12 in the liquid crystal display device 100 in Embodiment 1, each have a generally parallelogram shape with four right angles (more specifically, a generally square shape), each of four sides of which has an angle of about 45° with respect to the polarization axes P1 and P2. The plurality of branch portions 12b are located generally symmetrically with respect to the trunk portion 12a.

The liquid crystal display device 200 in this embodiment is different from the liquid crystal display device 100 in Embodiment 1 in the locations of the scanning lines 14 and the like. Hereinafter, this will be described more specifically.

The signal lines 15 in the liquid crystal display device 200 extend in a direction generally parallel to the polarization axis P2 of one of the pair of polarizing plates 50a and 50b (direction perpendicular to the polarization axis P1 of the other polarizing plate), and are each located so as to overlap the trunk portions 12a of the pixel electrodes 12 (more specifically, the vertical linear portions 12a2). The scanning lines 14 each include a first portion 14a extending in a direction having an angle of about 45° with respect to the polarization axes P1 and P2 and a second portion 14b extending in a direction generally perpendicular to the first portion 14a, and are each located between the pixel electrodes 12 adjacent to each other. Namely, each scanning line 14 extends zigzag as a whole between the pixel electrodes 12 adjacent to each other. The storage capacitance lines 16 extend in a direction generally perpendicular to the signal lines 15, and are each located so as to overlap the trunk portions 12a of the pixel electrodes 12 (more specifically, the horizontal linear portions 12a1).

In the liquid crystal display device 200 in this embodiment, each of the sides defining the external shape of the pixel electrode 12 has an angle of about 45° with respect to the polarization axes P1 and P2. Therefore, like in the liquid crystal display device 100 in Embodiment 1, the occurrence of the azimuthal angle shift in the vicinity of the pixel edge is suppressed, and as a result, the reduction of the transmittance and the deterioration of the viewing angle dependence of the γ characteristic are suppressed. The plurality of branch portions 12b of the pixel electrode 12 are located generally symmetrically with respect to the trunk portion 12a (at least in the vicinity of the trunk portion 12a), and the occupying ratio of the branch portions 12b in the vicinity of the horizontal linear portion 12a1 is approximately equal to the occupying ratio of the branch portions 12b in the vicinity of the vertical linear portion 12a2 (this corresponds to that the number of the branch portions 12b extending from the horizontal linear portion 12a1 is equal to the number of the branch portions 12b extending from the vertical linear portion 12a2 in the case where the width L of the branch portions 12b and the gap S are approximately the same in the entire pixel). Therefore, the adverse effect on the display quality caused by the azimuthal angle shift in the vicinity of the trunk portion 12a can be suppressed.

In the liquid crystal display device 200 in this embodiment, the signal lines 15 extend in a direction generally parallel to the polarization axis P2 of one of the pair of polarizing plates 50a and 50b (direction perpendicular to the polarization axis P1 of the other polarizing plate), and are each located so as to overlap the trunk portions 12a of the pixel electrodes 12. Thus, each signal line 15 overlaps borders between the liquid crystal domains (i.e., areas which do not contribute to the transmittance almost at all). Therefore, the loss of the transmittance by the signal line 15 is small. The signal line 15 overlaps the trunk portions 12a of the pixel electrodes 12. Hence, the electric fields leaking from the signal line 15 can be electrically shielded by the trunk portions 12a of the pixel electrodes 12a. Thus, the disturbance of the alignment caused by the electric fields leaking from the signal line 15 can be suppressed.

Moreover, the scanning lines 14 are each located between the pixel electrodes 12 adjacent to each other. Therefore, the loss of the transmittance caused by the scanning line 14 is reduced, and also the disturbance of the alignment caused by the electric fields leaking from the scanning line 14 can be suppressed. The storage capacitance lines 16 extend in a direction generally perpendicular to the signal lines 15, and are each located so as to overlap the trunk portions 12a of the pixel electrodes 12. Therefore, the loss of the transmittance caused by the storage capacitance line 16 is reduced, and also the disturbance of the alignment caused by the electric fields leaking from the storage capacitance line 16 can be suppressed.

A general shape of a liquid crystal display device is a generally parallelogram shape with four right angles, each of four sides of which is generally parallel to, or generally vertical to, the horizontal azimuth and the vertical azimuth. Thus, in a general liquid crystal display device, mount terminals are located at the horizontal azimuth (azimuthal angle of 0° or 180°) or at the vertical azimuth (azimuthal angle of 90° or 270°). Hence, when being located as described above, the lines can be drawn to the mount terminals more easily than when being located as in Embodiment 1.

In this embodiment, the signal lines 15 are each located so as to extend in a direction generally parallel to the polarization axis P2 (direction generally perpendicular to the polarization axis P1) and so as to overlap the trunk portions 12a of the pixel electrodes 12 (vertical linear portions 12a2), and also the scanning lines 14 are each located so as to extend zigzag as a whole between the pixel electrodes 12 adjacent to each other. An opposite structure to this may be adopted. Namely, the scanning lines 14 may be each located so as to extend in a direction generally parallel to the polarization axis P1 (direction generally perpendicular to the polarization axis P2) and so as to overlap the trunk portions 12a of the pixel electrodes 12 (horizontal linear portions 12a1), and the signal lines 15 may be each located so as to extend zigzag as a whole between the pixel electrodes 12 adjacent to each other.

Regarding the liquid crystal display device 200 in this embodiment and the conventional liquid crystal display device 500 shown in FIG. 23, the transmittance of the pixels was found by calculations and compared. For the calculations, the size of one pixel was set to 60 μm×60 μm in both of the liquid crystal display devices 200 and 500. Assuming that the pixel electrodes 12 and 512 are formed of a transparent oxidized metal material such as ITO, IZO or the like, the transmittance thereof was set to 100%. Assuming that the scanning lines 14 and 514 and the signal lines 15 and 515 are formed of a metal material such as Al, Mo or the like, the transmittance thereof was set to 0%. As a result of the calculations, it was found that the transmittance of the pixels of the liquid crystal display device 200 in this embodiment is about 25% higher than that of the conventional liquid crystal display device 500. As can be seen, the transmittance can be significantly improved by suppression of the azimuthal angle shift in the vicinity of the pixel edge.

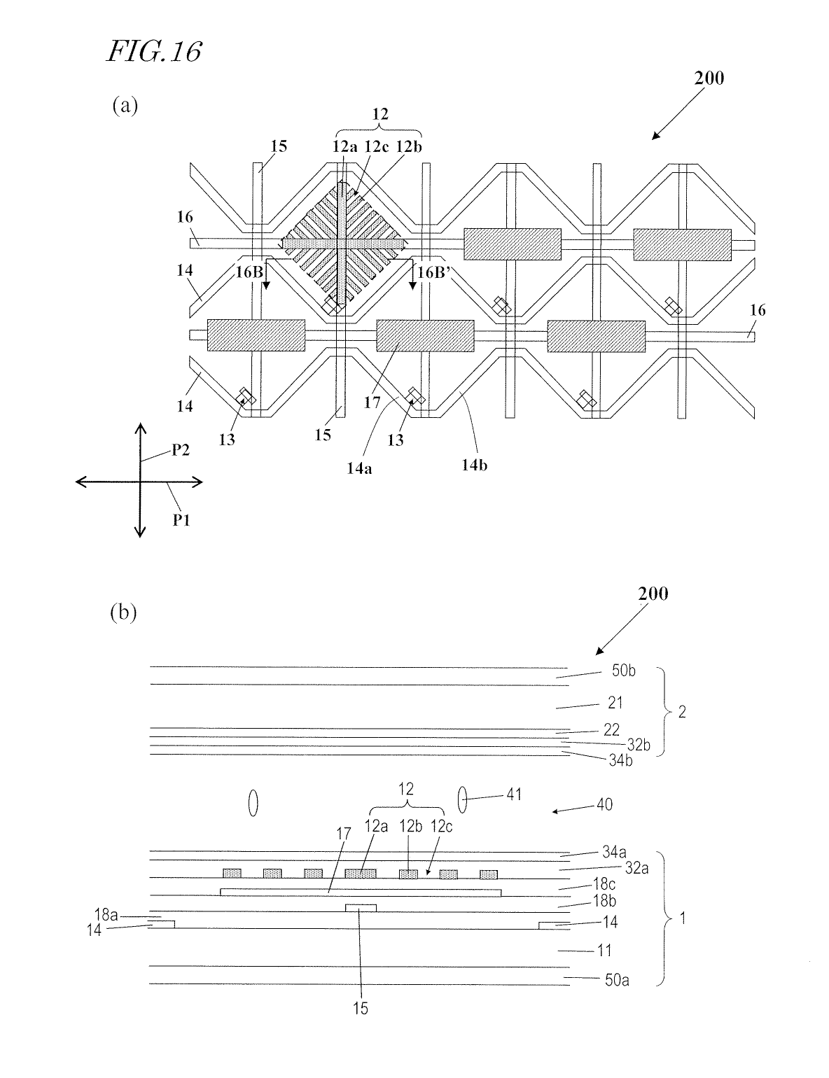

Now, a specific structure of the storage capacitance electrode 17 included in the liquid crystal display device 200 will be described. FIGS. 16(a) and (b) show an example of structure of the storage capacitance electrodes 17. In FIG. 16(a), the pixel electrodes 12 are omitted except for one pixel so that the planar shape of the storage capacitance electrodes 17 can be seen easily.

As shown in FIG. 16(a), the storage capacitance electrodes 17 each extend like a band in the same direction as the storage capacitance lines 16 (i.e., direction generally parallel to the polarization axis P1). As shown in FIG. 16(b), the storage capacitance electrode 17 overlaps the trunk portion 12a and the branch portions 12b of the pixel electrode 12 with the third insulating layer 18c interposed therebetween, and thus forms a storage capacitance.

In the example shown in FIGS. 16(a) and (b), the storage capacitance electrode 17 is wider than the trunk portion 12a (horizontal linear portion 12a1). Therefore, in the case where the storage capacitance electrode 17 is formed of a metal material such as Al, Mo or the like, the loss of the transmittance is large. The storage capacitance electrode 17, which is wider than the trunk portion 12a, also overlaps the slits 12c in addition to the trunk portion 12a and the branch portions 12b. Therefore, when a driving method of applying a voltage to the storage capacitance electrode 17 in the step of PSA processing is adopted, the alignment realized by the fishbone structure may be disturbed by the electric fields leaking from the storage capacitance electrode 17.

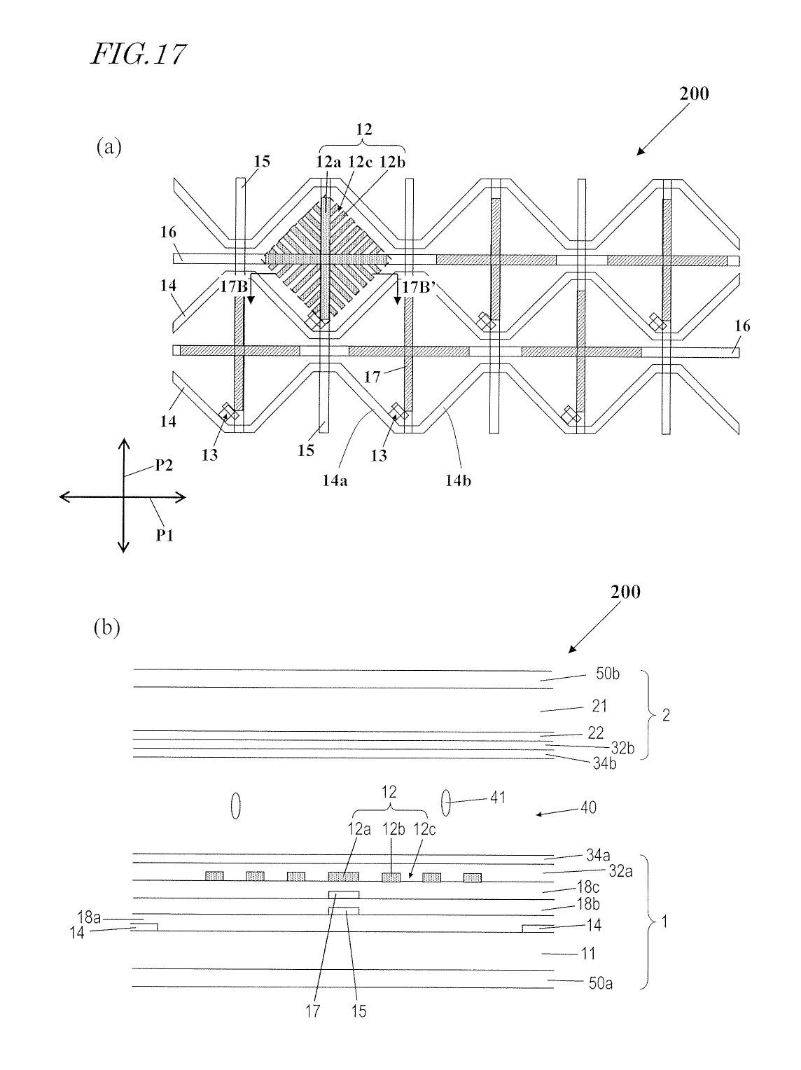

FIGS. 17(a) and (b) show another example of structure of the storage capacitance electrodes 17. In FIG. 17(a), the pixel electrodes 12 are omitted except for one pixel so that the planar shape of the storage capacitance electrodes 17 can be seen easily.

In the example shown in FIGS. 17(a) and (b), the storage capacitance electrodes 17 are each cross-shaped and located so as to overlap the trunk portion 12a. At such an location, the storage capacitance electrode 17 overlaps only borders between the liquid crystal domains (i.e., areas which do not contribute to the transmittance almost at all). Therefore, even though the storage capacitance electrode 17 is formed of a metal material, the loss of the transmittance is small. The storage capacitance electrode 17 overlaps the trunk portion 12a of the pixel electrode 12 and does not overlap the slits 12c. Hence, the electric fields leaking from the storage capacitance electrode 17 can be electrically shielded by the trunk portion 12a of the pixel electrode 12. Thus, the disturbance of the alignment caused by the leaking electric fields can be suppressed.

In any of the structures shown in FIG. 16 and FIG. 17, where the storage capacitance electrodes 17 are formed of a transparent conductive material, the loss of the transmittance can be reduced. Also where the storage capacitance lines 16 are formed of a transparent conductive material, the loss of the transmittance can be reduced. Namely, the transmittance can be improved by forming at least either of the storage capacitance lines 16 and the storage capacitance electrodes 17 of a transparent conductive material. Needless to say, from the viewpoint of further improving the transmittance, it is preferable that both of the storage capacitance lines 16 and the storage capacitance electrodes 17 are formed of a transparent conductive material. Specifically as the transparent conductive material, a transparent oxidized metal material such as ITO, IZO or the like is usable.

Regarding the case where the storage capacitance lines 16 and the storage capacitance electrodes 17 are formed of a metal material in the structure shown in FIG. 16 and the case where storage capacitance lines 16 and the storage capacitance electrodes 17 are formed of a transparent conductive material in the structure shown in FIG. 17, the transmittance of the pixels was found by calculations and compared. For the calculations, the size of one pixel was set to 60 μm×60 μm in both of the structures. Assuming that the pixel electrodes 12, and the storage capacitance lines 16 and the storage capacitance electrodes 17 in the structure of FIG. 17, are formed of a transparent conductive material such as ITO, IZO or the like, the transmittance thereof was set to 100%. Assuming that the scanning lines 14 and the signal lines 15, and the storage capacitance lines 16 and the storage capacitance electrodes 17 in the structure of FIG. 16, are formed of a metal material such as Al, Mo or the like, the transmittance thereof was set to 0%. As a result of the calculations, it was found that the transmittance of the pixels of the latter structure (structure of FIG. 17) is about 5% higher than that of the former structure (structure of FIG. 16).

### Embodiment 3

FIGS. 18(a) and (b) show a liquid crystal display device 300 in this embodiment. FIG. 18(a) is a plan view schematically showing the liquid crystal display device 300, and FIG. 18(b) is a cross-sectional view taken along line 18B-18B′ in FIG. 18(a).

Pixel electrodes 12 in the liquid crystal display device 300 in this embodiment, like the pixel electrodes 12 in the liquid crystal display devices 100 and 200 in Embodiments 1 and 2, each have a generally parallelogram shape with four right angles (more specifically, a generally square shape), each of four sides of which has an angle of about 45° with respect to the polarization axes P1 and P2. The plurality of branch portions 12b are located generally symmetrically with respect to the trunk portion 12a.

The liquid crystal display device 300 in this embodiment is different from the liquid crystal display devices 100 and 200 in Embodiments 1 and 2 in the locations of the scanning lines 14 and the like. Hereinafter, this will be described more specifically.

The scanning lines 14 in the liquid crystal display device 300 extend in a direction generally parallel to the polarization axis P1 of one of the pair of polarizing plates 50a and 50b (direction perpendicular to the polarization axis P2 of the other polarizing plate), and are each located so as to overlap the trunk portions 12a of the pixel electrodes 12 (more specifically, the horizontal linear portions 12a1). The signal lines 15 extend in a direction generally perpendicular to the scanning lines 14 (i.e., direction generally parallel to the polarization axis P2 and generally perpendicular to the polarization axis P1), and are each located so as to overlap the trunk portions 12a of the pixel electrodes 12 (more specifically, the vertical linear portions 12a2).

The storage capacitance lines 16 each include a first portion 16a extending in a direction having an angle of about 45° with respect to the polarization axes P1 and P2 and a second portion 16b extending in a direction generally perpendicular to the first portion 16a, and are each located between the pixel electrodes 12 adjacent to each other. Namely, each storage capacitance line 16 extends zigzag as a whole between the pixel electrodes 12 adjacent to each other. The storage capacitance electrodes 17 are cross-shaped and are each located so as to overlap the trunk portion 12a of the pixel electrode 12.

In the liquid crystal display device 300 in this embodiment, each of the sides defining the external shape of the pixel electrode 12 has an angle of about 45° with respect to the polarization axes P1 and P2. Therefore, like in the liquid crystal display devices 100 and 200 in Embodiments 1 and 2, the occurrence of the azimuthal angle shift in the vicinity of the pixel edge is suppressed, and as a result, the reduction of the transmittance and the deterioration of the viewing angle dependence of the γ characteristic are suppressed. The plurality of branch portions 12b of the pixel electrode 12 are located generally symmetrically with respect to the trunk portion 12a. Therefore, the adverse effect on the display quality caused by the azimuthal angle shift in the vicinity of the trunk portion 12a can be suppressed.

In the liquid crystal display device 300 in this embodiment, the scanning lines 14 and the signal lines 15 extend in a direction generally parallel to, or generally vertical to, the polarization axis P1 of one of the pair of polarizing plates 50a and 50b, and are each located so as to overlap the trunk portions 12a of the pixel electrodes 12. Thus, the scanning lines 14 and the signal lines 15 each overlap borders between the liquid crystal domains (i.e., areas which do not contribute to the transmittance almost at all). Therefore, the loss of the transmittance by the scanning line 14 and the signal line 15 is reduced. The scanning line 14 and the signal line 15 each overlap the trunk portions 12a. Hence, the electric fields leaking from the scanning line 14 and the signal line 15 can be electrically shielded by the trunk portions 12a of the pixel electrodes 12a. Thus, the disturbance of the alignment caused by the electric fields leaking from the scanning line 14 and the signal line 15 can be suppressed.

Moreover, the storage capacitance lines 16 are each located between the pixel electrodes 12 adjacent to each other. Therefore, the loss of the transmittance caused by the storage capacitance line 16 is reduced, and also the disturbance of the alignment caused by the electric fields leaking from the storage capacitance line 16 can be suppressed.

When the lines are located as described above, like when the lines are located as described in Embodiment 2, there is an effect that the lines can be drawn to the mount terminal more easily than when being located as in Embodiment 1.

As described above, the storage capacitance electrodes 17 are each cross-shaped and located so as to overlap the trunk portion 12a. The storage capacitance electrode 17 overlaps only borders between the liquid crystal domains (i.e., areas which do not contribute to the transmittance almost at all). Therefore, even though the storage capacitance electrode 17 is formed of a metal material, the loss of the transmittance is small. The storage capacitance electrode 17 overlaps the trunk portion 12a of the pixel electrode 12 and does not overlap the slits 12c. Hence, the electric fields leaking from the storage capacitance electrode 17 can be electrically shielded by the trunk portion 12a of the pixel electrode 12. Thus, the disturbance of the alignment caused by the leaking electric fields can be suppressed.

### Other Embodiments

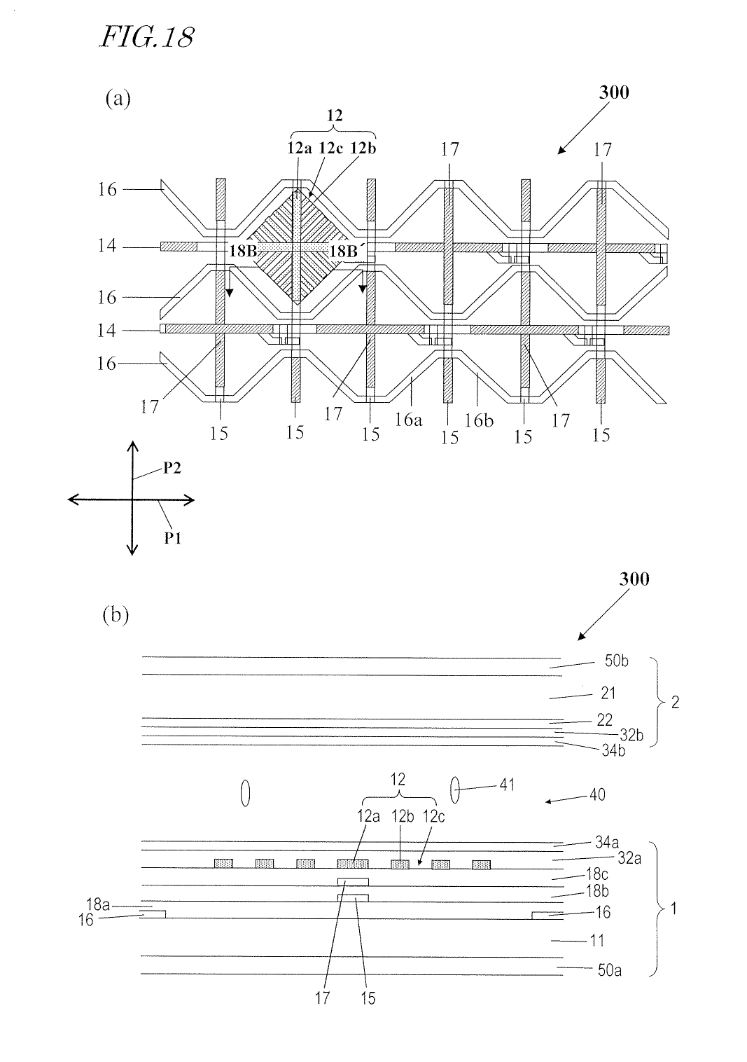

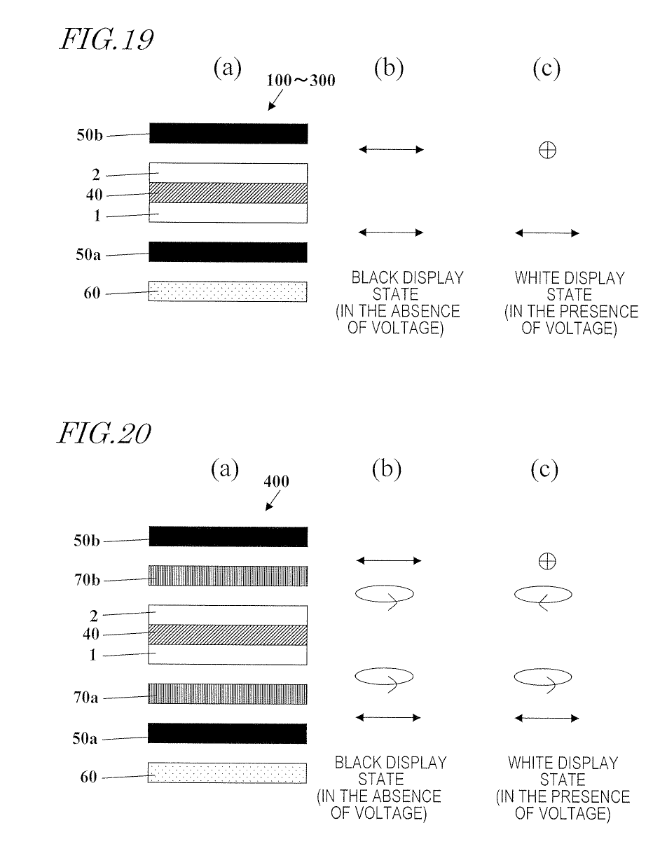

In the liquid crystal display devices 100 through 300 in Embodiments 1 through 3, linear polarization transmitted through the rear-side polarizing plate 50a is incident on the liquid crystal layer 40, and the liquid crystal layer 40 modulates the linear polarization to provide display. By contrast, by a structure in which circular polarization is incident on the liquid crystal layer 40 and the liquid crystal layer 40 modulates the circular polarization to provide display (i.e., structure using circular polarization), brighter display can be realized. A reason for this will be described more specifically with reference to FIG. 19 through FIG. 22.

FIG. 19(a) schematically shows a cross-sectional structure of the liquid crystal display devices 100 through 300. FIGS. 19(b) and (c) each schematically show a polarization state of light passing the inside of the liquid crystal display devices 100 through 300. FIG. 19(b) corresponds to black display (in the absence of a voltage), and FIG. 19(c) corresponds to white display (in the presence of a voltage). FIG. 20(a) schematically shows a cross-sectional structure of a liquid crystal display device 400, which uses circular polarization. FIGS. 20(b) and (c) each schematically show a polarization state of light passing the inside of the liquid crystal display device 400. FIG. 20(b) corresponds to black display (in the absence of a voltage), and FIG. 20(c) corresponds to white display (in the presence of a voltage). In both of the FIG. 19 and FIG. 20, the polarization axis of the rear-side polarizing plate 50a is parallel to the left-right direction of the paper sheet of the figures, and the polarization axis of the observer-side polarizing plate 50b is parallel to the direction vertical to the paper sheet of the figures.

As shown in FIG. 19(a), an illumination device (backlight) 60 is provided at the rearmost position of the liquid crystal display devices 100 through 300. As shown in FIGS. 19(b) and (c), light emitted from the backlight passes the rear-side polarizing plate 50a to become linear polarization having a polarization direction which is parallel to the left-right direction of the paper sheet of the figures. As shown in FIG. 19(b), in the absence of a voltage, the polarization state of this linear polarization is not changed even after the linear polarization passes the liquid crystal layer 40. Therefore, the linear polarization reaches the observer-side polarizing plate 50b with the polarization state being kept (i.e., with the polarization direction being still parallel to the left-right direction of the paper sheet of the figures), and is absorbed. Therefore, in the absence of a voltage, black display is provided. As shown in FIG. 19(c), in the presence of a voltage, this linear polarization passes the liquid crystal layer 40 to have the polarization direction thereof rotated by 90°. Therefore, the linear polarization reaches the observer-side polarizing plate 50b as linear polarization having a polarization direction which is parallel to the direction vertical to the paper sheet of the figures, and is output toward the observer. Therefore, in the presence of a voltage, white display is provided.

Unlike the liquid crystal display devices 100 through 300, the liquid crystal display device 400 shown in FIG. 20(a) includes a first phase plate 70a and a second phase plate 70b. The first phase plate 70a is located between the rear-side polarizing plate 50a and the liquid crystal layer 40, and the second phase plate 70b is located between the observer-side polarizing plate 50b and the liquid crystal layer 40. Specifically, the first phase plate 70a is a λ/4 plate having a delay axis which has an angle of about 45° with respect to the polarization axis of the polarizing plate 50a. Specifically, the second phase plate 70b is a λ/4 plate having a delay axis generally perpendicular to the delay axis of the first phase plate 70a. The TFT substrate 1 in the liquid crystal display device 400 has substantially the same structure as that of the TFT substrate 1 in the liquid crystal display devices 100 through 300.

As shown in FIGS. 20(b) and (c), light emitted from the backlight 60 passes the rear-side polarizing plate 50a to become linear polarization having a polarization direction which is parallel to the left-right direction of the paper sheet of the figures. This linear polarization passes the first phase plate 70a to become clockwise circular polarization. As shown in FIG. 20(b), in the absence of a voltage, the polarization state of the circular polarization is not changed even after the circular polarization passes the liquid crystal layer 40. Therefore, the circular polarization reaches the second phase plate 70b with the polarization state being kept (i.e., as the clockwise circular polarization), and passes the second phase plate 70b to become linear polarization having a polarization direction which is parallel to the left-right direction of the paper sheet of the figures. This linear polarization reaches the observer-side polarizing plate 50b and is absorbed. Therefore, in the absence of a voltage, black display is provided. As shown in FIG. 20(c), in the presence of a voltage, the clockwise circular polarization which has passed the first phase plate 70a passes the liquid crystal layer 40 to become counterclockwise circular polarization. This counterclockwise circular polarization passes the second phase plate 70b to become linear polarization having a polarization direction which is parallel to the direction vertical to the paper sheet of the figures. This linear polarization reaches the observer-side polarizing plate 50b and is absorbed. Therefore, in the presence of a voltage, white display is provided.

As described above, in the liquid crystal display devices 100 through 300, the light incident on the liquid crystal layer 40 is linear polarization. In this case, the transmittance of a certain area of the pixel depends on an angle made by the alignment azimuth of the liquid crystal molecules 41 in this area and the polarization direction (incident azimuth) of the linear polarization incident on the liquid crystal layer 40. Specifically, when the angle made by the alignment azimuth of the liquid crystal molecules 41 and the incident azimuth is 45°, the transmittance is maximum; whereas when the angle is 0° or 90°, the transmittance is minimum. This occurs because of the birefringence property of the liquid crystal molecules 41. In actuality, however, all the liquid crystal molecules 41 in a liquid crystal domain are not aligned in the same azimuth completely. Therefore, due to the above-described incident azimuth dependence of the transmittance, the transmittance is locally lowered.

By contrast, in the liquid crystal display device 400, the light incident on the liquid crystal layer 40 is circular polarization. In this case, the transmittance does not have the above-described incident azimuth dependence. Namely, regardless of the azimuth in which the liquid crystal molecules 41 are aligned, the liquid crystal molecules 41 contribute to the transmittance. Hence, brighter display can be realized.

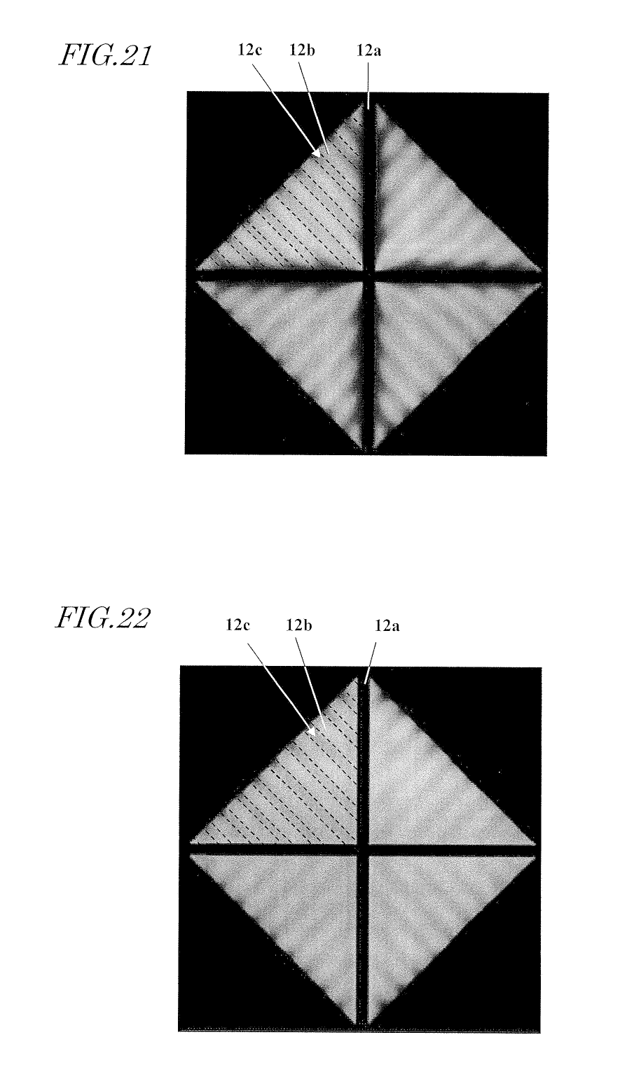

FIG. 21 shows the transmission characteristic, obtained by calculations, of one pixel in the liquid crystal display device 100 in Embodiment 1 (adopting a structure using linear polarization) in the presence of a voltage. FIG. 22 shows the transmission characteristic, obtained by calculations, of one pixel in the liquid crystal display device 400 in this embodiment (adopting a structure using circular polarization) in the presence of a voltage. The liquid crystal display device 400 has the same structure as that of the liquid crystal display device 100 except that the liquid crystal display device 400 includes the first phase plate 70a and the second phase plate 70b. The size of one pixel was set to 80 μm×80 μm. The storage capacitance electrode 17 formed of a metal material was located to overlap the trunk portion 12a.

As seen from FIG. 21, in the liquid crystal display device 100 using linear polarization, the transmittance is lowered on the slits 12c and in the vicinity of the trunk portion 12a. This is caused by the liquid crystal molecules 41 aligned in an azimuth shifted from the alignment azimuth defined by the slits 21c.

By contrast, as can be seen from FIG. 22, in the liquid crystal display device 400 using circular polarization, the reduction of the transmittance on the slits 12c and in the vicinity of the trunk portion 12a is alleviated. This occurs for the following reason. Since the circular polarization is incident on the liquid crystal layer 40, the transmittance does not have the incident azimuth dependence, and so the liquid crystal molecules 41 aligned in an azimuth shifted from the alignment azimuth defined by the slits 21c also contribute to the transmittance. The transmittance of the example shown in FIG. 22 is about 10% higher than the transmittance of the example shown in FIG. 21.

As can be seen, adoption of a structure using circular polarization can alleviate the reduction of the transmittance on the slits 12c and in the vicinity of the trunk portion 12a. It should be noted that on the slits 12c on which the conductive film is not provided, the transmittance is slightly lowered even if the circular polarization is used. This occurs for the following reason. The effective voltage applied on the slits 12c is lower than that applied on the branch portions 12b, and so the liquid crystal molecules 41 are inclined less. In order to improve the transmittance on the slits 12c, it is preferable that the widths of the lines and spaces of the striped pattern (i.e., the width L of the branch portions 12b and the gap S) are decreased (specifically, decreased to the range of 1.5 μm or greater and 5.0 μm or less).

### INDUSTRIAL APPLICABILITY

The present invention is preferably usable for a liquid crystal display device in which a 4-domain alignment structure is formed in each of pixels when a voltage is applied. A liquid crystal display device according to the present invention is preferably usable as a display section of any of various types of electronic devices including mobile phones, PDAs, notebook computers, monitors, TV receivers and the like.

### REFERENCE SIGNS LIST

1 Active matrix substrate (TFT substrate)

2 Counter substrate (color filter substrate)

12 Pixel electrode

12a Trunk portion

12b, 12b1, 12b2, 12b3, 12b4 Branch portion

12c Slit

13 Thin film transistor (TFT)

14 Scanning line

15 Signal line

16 Storage capacitance line

17 Storage capacitance electrode

22 Counter electrode

32a, 32b Vertical alignment film

34a, 34b Alignment sustaining layer

40 Liquid crystal layer

41 Liquid crystal molecules

50a, 50b Polarizing plate

70a First phase plate

70b Second phase plate

100, 200, 300, 400 Liquid crystal display device

1. A liquid crystal display device comprising a plurality of pixels and a pair of polarizing plates located in crossed Nicols and providing display in a normally black mode, wherein:
each of the plurality of pixels includes:
a liquid crystal layer containing liquid crystal molecules having a negative dielectric anisotropy;
a pixel electrode and a counter electrode facing each other with the liquid crystal layer interposed therebetween;
a pair of vertical alignment films respectively provided between the pixel electrode and the liquid crystal layer and between the counter electrode and the liquid crystal layer; and
a pair of alignment sustaining layers respectively provided on surfaces of the pair of vertical alignment films on the liquid crystal layer side and formed of a photopolymerizable material;
wherein:
the pixel electrode includes a cross-shaped trunk portion located so as to overlap polarization axes of the pair of polarizing plates, a plurality of branch portions extending from the trunk portion in a direction having an angle of about 45° with respect thereto, and a plurality of slits formed between the plurality of branch portions;
the pixel electrode has an overall shape which is a generally parallelogram shape with four right angles, each of four sides of which has an angle of about 45° with respect to The polarization axes of the pair of polarizing plates; and
the plurality of branch portions are located generally symmetrically with respect to the trunk portion.

2. The liquid crystal display device of claim 1, which includes a first substrate including the pixel electrode and a second substrate including the counter electrode;
wherein:
the first substrate further includes a switching element electrically connected to the pixel electrode, a scanning line for supplying a scanning signal to the switching element, and a signal line for supplying an image signal to the switching element; and
at least one of the scanning line and the signal line extends in a direction having an angle of about 45° with respect to the polarization axes of the pair of polarizing plates, and is located between the pixel electrodes adjacent to each other.

3. The liquid crystal display device of claim 2, wherein:
both of the scanning line and the signal line extend in a direction having an angle of about 45° with respect to the polarization axes of the pair of polarizing plates, and are located between the pixel electrodes adjacent to each other.

4. The liquid crystal display device of claim 1, which includes a first substrate including the pixel electrode and a second substrate including the counter electrode;
wherein:
the first substrate further includes a switching element electrically connected to the pixel electrode, a scanning line for supplying a scanning signal to the switching element, and a signal line for supplying an image signal to the switching element; and
at least one of the scanning line and the signal line extends in a direction generally parallel to, or generally perpendicular to, the polarization axis of one of the pair of polarizing plates, and is located so as to overlap the trunk portion of the pixel electrode.

5. The liquid crystal display device of claim 4, wherein:
both of the scanning line and the signal line extend in a direction generally parallel to, or generally perpendicular to, the polarization axis of one of the pair of polarizing plates, and are located so as to overlap the trunk portion of the pixel electrode.

6. The liquid crystal display device of claim 5, wherein:
the first substrate further includes a storage capacitance line; and
the storage capacitance line includes a first portion extending in a direction having an angle of about 45° with respect to the polarization axes of the pair of polarizing plates and a second portion extending in a direction generally perpendicular to the first portion, and is located between the pixel electrodes adjacent to each other.

7. The liquid crystal display device of claim 4, wherein:
one of the scanning line and the signal line extends In a direction generally parallel to, or generally perpendicular to, the polarization axis of one of the pair of polarizing plates, and is located so as to overlap the trunk portion of the pixel electrode; and
the other of the scanning line and the signal line includes a first portion extending in a direction having an angle of about 45° with respect to the polarization axes of the pair of polarizing plates and a second portion extending in a direction generally perpendicular to the first portion, and is located between the pixel electrodes adjacent to each other.

8. The liquid crystal display device of claim 7, wherein:
the first substrate further includes a storage capacitance line;
the signal line extends in a direction generally parallel to, or generally perpendicular to, the polarization axis of one of the pair of polarizing plates, and is located so as to overlap the trunk portion of the pixel electrode;
the scanning line includes a first portion extending in a direction having an angle of about 45° with respect to the polarization axes of the pair of polarizing plates and a second portion extending in a direction generally perpendicular to the first portion, and is located between the pixel electrodes adjacent to each other; and
the storage capacitance line extends in a direction generally perpendicular to the signal line, and is located so as to overlap the trunk portion of the pixel electrode.

9. The liquid crystal display device of claim 1, wherein:
the first substrate further includes a storage capacitance line and a storage capacitance electrode electrically connected to the storage capacitance line; and
the storage capacitance electrode is cross-shaped and is located so as to overlap the trunk portion.

10. The liquid crystal display device of claim 9, wherein at least one of the storage capacitance line and the storage capacitance electrode is formed of a transparent conductive material.

11. The liquid crystal display device of claim 9, wherein both of the storage capacitance line and the storage capacitance electrode are formed of a transparent conductive material.

12. The liquid crystal display device of claim 1, wherein circular polarization is incident on the liquid crystal layer, and display is provided by the liquid crystal layer modifying the circular polarization.

13. The liquid crystal display device of claim 12, further comprising a first phase plate located between one of the pair of polarizing plates and the liquid crystal layer, and a second phase plate located between the other of the pair of polarizing plates and the liquid crystal layer.

14. The liquid crystal display device of claim 13, wherein:
the first phase plate is a λ/4 plate having a delay axis which has an angle of about 45° with respect to the polarization axis of the one of the pair of polarization axes; and
the second phase plate is a λ/4 plate having a delay axis generally perpendicular to the delay axis of the first phase plate.

15. The liquid crystal display device of claim 1, wherein:
when a voltage is applied between the pixel electrode and the counter electrode, four liquid crystal domains are formed in the liquid crystal layer in each of the plurality of pixels;
four directors respectively representative of alignment directions of the liquid crystal molecules in the four liquid crystal domains have different azimuths from one another; and
each of the azimuths of the four directors has an angle of about 45° with respect to the polarization axes of the pair of polarizing plates.

16. The liquid crystal display device of claim 15, wherein:
the four liquid crystal domains are a first liquid crystal domain in which the azimuth of the director is a first azimuth, a second liquid crystal domain in which the azimuth of the director is a second azimuth, a third liquid crystal domain in which the azimuth of the director is a third azimuth, and a fourth liquid crystal domain in which the azimuth of the director is a fourth azimuth; and a difference between any two azimuths among the first azimuth, the second azimuth, the third azimuth and the fourth azimuth is approximately equal to an integral multiple of 90°; and
the azimuths of the directors of the liquid crystal domains adjacent to each other with the trunk portion interposed therebetween are different from each other by about 90°.
